(19) United States
(12) Patent Application Publication
(10) Pub. No.: US 2018/0084776 A1
(43) Pub. Date: Mar. 29, 2018

(54) Agricultural Composition

(71) Applicant: Agresearch Limited, Hamilton (NZ)

(72) Inventors: Mark Robin Holmes HURST, Hamilton (NZ); Jayanthi SWAMINATHAN, Hamilton (NZ)

(73) Assignee: Agresearch Limited, Hamilton (NZ)

(21) Appl. No.: 15/566,156

(22) PCT Filed: Apr. 13, 2016
(86) PCT No.: PCT/NZ2016/050059

§ 371 Date: Oct. 12, 2017

(30) Foreign Application Priority Data
Apr. 13, 2015 (NZ) 706932
Feb. 9, 2016 (NZ) 716740

(51) Int. Cl. A01N 25/12; A01N 25/00; A01N 63/04

(52) U.S. Cl. CPC A01N 25/12; A01N 63/04; A01N 25/006

(57) ABSTRACT

A granular composition that comprises one or more microorganisms, two or more plant powders and a biodegradable water-absorbent agent. Also provided is a method of producing a granular composition by admixing a composition comprising two or more plant powders and a biodegradable water-absorbent agent, and (i) one or more lubricants to form a dough, and processing the dough to form granules, or (ii) coating a substrate with the dough to form the granular composition. The microorganism can be located in the admixture, the dough or both the admixture and the dough. The granular composition is applied to soil to, for example, kill or control pests, maintain or increase plant or crop growth, maintain or increase pasture production, maintain or increase plant, crop or pasture yield, deliver probiotics to grazing animals or livestock, and/or bioremediate the soil.

### FIELD OF THE INVENTION

The present invention relates to an agricultural composition comprising one or more microorganisms, its methods of preparation and its application to soil.

### BACKGROUND TO THE INVENTION

Microorganisms such as bacteria and fungi are useful alternatives to chemical agents for the improvement and/or maintenance of soil and plant health, including the control of pests.

The utility of microorganisms for application to soil is limited by the sensitivity of such microorganisms to environmental conditions after application and during storage of compositions comprising microorganisms.

Compositions that adequately protect the microorganism from environmental exposure are costly to manufacture.

It is an object of the present invention to provide an agricultural composition comprising one or more microorganisms, or to at least provide the public with a useful choice.

### SUMMARY OF THE INVENTION

In a first aspect, the invention provides a granular composition comprising one or more microorganisms, two or more plant powders and a biodegradable water-absorbent agent.

In a further aspect, the invention provides a granular composition comprising one or more microorganisms having a loading of less than 10¹⁰ cells per gram of granular composition, two or more plant powders and a biodegradable water-absorbent agent capable of absorbing at least 10% of its dry weight in water.

In a further aspect, the invention provides a granular composition comprising one or more bacteria, two or more plant powders and a biodegradable water-absorbent agent capable of absorbing at least 10% of its dry weight in water.

In a further aspect the invention relates to a method of producing a granular composition, the method comprising

admixing a composition comprising one or more microorganisms, two or more plant powders, a biodegradable water-absorbent agent capable of absorbing at least 10% of its dry weight in water, and one or more lubricants to form a dough, and

processing the dough to form the granular composition.

In a further aspect the invention relates to a method of producing a granular composition, the method comprising

admixing a composition comprising one or more microorganisms, two or more plant powders and a biodegradable water-absorbent agent capable of absorbing at least 10% of its dry weight in water, to form a dough, and

coating a substrate with the dough to form the granular composition.

In a further aspect the invention relates to a method of producing a granular composition, the method comprising

admixing a composition comprising two or more plant powders, a biodegradable water-absorbent agent capable of absorbing at least 10% of its dry weight in water, and one or more lubricants to form a dough, and

coating the dough with an exterior coating comprising one or more microorganisms to form the granular composition.

In a further aspect the invention relates to a method of delivering one or more microorganisms to soil, comprising applying the granular composition of the invention on to soil.

In a further aspect, the invention provides a method of controlling insect pests, the method comprising placing insecticidal granular compositions in proximity to an insect pest, the granular compositions being as claimed above.

Any one or more of the following embodiments may relate to any of the aspects described herein or any combination thereof.

In various embodiments the granular composition has
a) a bulk density of from about 0.2 g/cm³ to about 1.5 g/cm³, or
b) a mean diameter (weight-based) of from about 1 mm to 5 mm, or
c) a particle size distribution whereby at least 90% of the granular composition have a diameter of from 1 mm to 5 mm, or
d) a particle size distribution whereby at least 90% of the granular composition has a diameter within 1 mm of the mean diameter, or
e) a water activity of from about 0.2 to about 0.95, or
f) a hardness (the maximum load to crush) of from about 10 N to about 100 N, or
g) a brittleness of from about 10 N to about 100 N, or
h) a porosity of from about 1 to about 1000, or
i) a swellability of from about 50 to about 300%, or
j) any combination of two or more of (a) to (i) above.

In some embodiments the granular composition has a bacterial loading of less than about 10¹¹, 10¹⁰, 10⁹, 10⁸, 10⁷, 10⁶, 10⁵ or 10⁴ cells per gram of granular composition, and useful ranges may be selected between any of these values.

In various embodiments said two or more plant powders comprises a bran as at least one of said two or more plant powders.

In various embodiments the granular composition comprises a phagostimulant.

In various embodiments the granular composition comprises one or more polysaccharides.

In various embodiments the granular composition comprises one or more CO₂-generating agents.

In various embodiments the granular composition comprises at least about 1×10⁴, 1×10⁵ or 1×10⁶ cfu/g after storage at 4° C. for 14 days, and useful ranges may be selected between any of these values.

In various embodiments the granular composition retains its integrity for at least about 48 hours after contacting about 0.1, 0.2, 0.3, 0.4, 0.5, 0.6, 0.7, 0.8, 0.9 or 1 ml of water per gram of granular composition.

In various embodiments the microorganism is (i) one or more bacteria, (ii) one or more fungi, or (iii) one or more bacteria and one or more fungi.

In various embodiments the bacteria or fungi are agriculturally and/or horticulturally useful, for example, the bacteria is pesticidal and/or insecticidal, and/or supports plant growth and/or development, or any combination thereof.

In various embodiments the one or more bacteria may comprise Serratia (for example, Serratia entomophilia or Serratia proteomaculans), Xanthamonas, Pseudomonas, Rhizobium, Bifidobacterium, Lactobacillus, Streptococcus (Enterococcus), Yersinia (for example, Yersinia entomophaga), Pseudomonas, Bacillus, Pasteuria, Azobacter, Enterobacter, Azospirillum, Cyanobacteria, Paecilomyces, Streptomycetes, Chromobacterium, Rhanella, Burkholderia, Paenibacillus, Collimonas, Sinorhizobium, Pantoea, Lecanicillum, Erwinia, Pediococus, Leuconostoc, Aeromonas, Neptunomonas, Klebsiella, Ponchonia, Brevibacillus, Acinetobacter or a combination of any two or more thereof.

In various embodiments the one or more fungi may comprise Beauveria, Penicillium, Metarhizium, Trichoderma, Gliocladium, Coniothyrium, Verticillium, Sclerotinia or a combination of any two or more thereof.

In various embodiments the bran may comprise wheat bran, rice bran, oat bran, barley bran, rye bran, triticale bran, corn (maize) bran, amaranth bran, millet bran, teff bran, quinoa bran, buckwheat bran, sorghum bran or a combination of any two or more thereof. In a preferred embodiment the bran comprises wheat bran.

In various embodiments the granular composition may comprise about 5, 10, 15, 20, 25, 30, 35, 40, 45 or about 50% by weight of bran, and useful ranges may be selected between any of these values.

In various embodiments the plant powder may comprise wheat flour, rice powder, oat flour, barley flour, rye flour, triticale flour, corn (maize) flour, amaranth flour, millet flour, teff flour, quinoa flour, buckwheat flour, sorghum flour or a combination of any two or more thereof. In a preferred embodiment the plant powder comprises rice powder or maize flour.

In various embodiments the granular composition may comprise about 5, 10, 15, 20, 25, 30, 35, 40, 45, 50, 55, 60, 65, 70, 75, 80 or about 85% by weight of the one or more plant powders, and useful ranges may be selected between any of these values.

In one embodiment the biodegradable water-absorbent agent is capable of absorbing at least 10% of its dry weight in water.

In various embodiments the biodegradable water-absorbent agent is capable of absorbing at least 10, 20, 30, 40, 50, 60, 70, 80, 90 or 100% water based on its dry weight, and useful ranges may be selected between any of these values.

In various embodiments the biodegradable water-absorbent agent is capable of absorbing at least 100, 150, 200, 300, 400, 500, 600, 700, 800, 900 or 1,000% water based on its dry weight, and useful ranges may be selected between any of these values.

In some embodiments the biodegradable water-absorbent agent is a polymer.

In one embodiment the biodegradable water-absorbent agent is selected from the group comprising starches, cross-linked polymers, and peat.

In various embodiments the biodegradable water-absorbent agent is a polymer selected from the group comprising a cold-water soluble starch, a pre-gelatinised starch, a cross-linked polymer, or a combination of any two or more thereof. In various embodiments the biodegradable water-absorbent polymer may comprise potato starch, corn starch, sodium starch glycolate, cellulose, methylcellulose, peat, rice powder, sodium alginate, polyvinylpyrrolidone, sodium carboxymethyl cellulose, croscarmellose sodium or a combination of any two or more thereof. In a preferred embodiment the biodegradable water-absorbent agent comprises potato starch.

In various embodiments the granular composition may comprise about 0.05, 0.1, 0.15, 0.2, 0.25, 0.3, 0.35, 0.4, 0.5, 0.6, 0.7, 0.8, 0.9, 1, 1.5, 2, 2.5, 3, 3.5, 4, 4.5 or about 5% by weight of the a biodegradable water-absorbent agent, and useful ranges may be selected between any of these values.

In various embodiments the one or more saccharides may comprise a monosaccharide, a disaccharide, an oligosaccharide, a polysaccharide, or a sugar product, or a combination of any two or more thereof. In various embodiments the one or more saccharides may comprise glucose, fructose, maltose, sucrose, lactose, trehalose, honey, such as clover honey, molasses, glucose syrup, corn syrup, for example, high fructose corn syrup, golden syrup, treacle, cane sugar, refined sugar, raw sugar, brown sugar, white sugar, maltodextrin, cornflour, wheat flour, or a combination of any two or more thereof.

In various embodiments the granular composition may comprise about 3, 5, 10, 15, 20, 25, 30, 35, 40, 45 or about 50% by weight of saccharides, and useful ranges may be selected between any of these values.

In various embodiments the granular composition may comprise about 10, 20, 30, 40, 50, 60, 70, 80, or 90% by weight of an inert bulking agent, and useful ranges may be selected between any of these values. In some embodiments the inert bulking agent is gypsum or talc, such as a clay.

In various embodiments the one or more saccharides may be in the form of a powder or a liquid such as a syrup, or a combination of a powder and a liquid. For example, in one exemplary embodiment the one or more saccharides may comprise white sugar, and honey. In one embodiment the one or more saccharides may comprise a powder and a liquid in a ratio of 200:1, 175:1, 150:1, 125:1, 100:1, 80:1, 75:1 60:1, 50:1, 40:1, 30:1, 20:1 or 10:1.

In some embodiments the granular composition contains a lubricant.

In various embodiments the lubricant may be selected from the group comprising a lipid such as a fat or oil. In various embodiments the lubricant may be selected from the group comprising magnesium stearate, vegetable stearin, stearic acid, a mineral, a fatty acid ester, or an inorganic material, a polymer or a combination of any two or more thereof. In other embodiments the mineral may comprise a talc or silica. In a preferred embodiment the lubricant is magnesium stearate.

In various embodiments the granular composition may comprise about 0.05, 0.1, 0.15, 0.2, 0.25, 0.3, 0.35, 0.4, 0.5, 0.6, 0.7, 0.8, 0.9 or about 1% by weight of the lubricant, and useful ranges may be selected between any of these values.

In various embodiments the granular composition may additionally comprise one or more processed cereals selected from the group comprising wheat, corn, rice, oats, barley, amaranth, millet, quinoa, sorghum, and buckwheat. For example, in various embodiments the one or more processed cereals may comprise kibbled wheat, puffed wheat, ground corn (corn grits), puffed rice, rolled oats, puffed oats, puffed barley, puffed amaranth, puffed millet, puffed quinoa, puffed sorghum, or puffed buckwheat. In a preferred embodiment the composition additionally comprises kibbled wheat and ground corn.

In various embodiments the granular composition may comprise about 5, 10, 15, 20, 25, 30, 35, 40, 45, 50, 55 or about 60% by weight of the one or more processed cereals, and useful ranges may be selected between any of these values.

In various embodiments the granular composition comprises the bran and the one or more other plant powders in a ratio of about 8:1, 7:1, 6:1, 5:1, 4:1, 3:1, 2:1, 3:2, 1:1, 2:3, 1:2, 1:3 or about 1:4 by weight, and useful ranges may be selected between any of these values.

In various embodiments the granular composition comprises the bran and the one or more saccharides in a ratio of about 5:1, 4:1, 3:1, 2:1, 3:2, 1:1, 2:3, 1:2, 1:3, 1:4 or about 1:5 by weight, and useful ranges may be selected between any of these values.

In various embodiments the granular composition comprises the one or more plant powders and the one or more saccharides in a ratio of about 8:1, 7:1, 6:1, 5:1, 4:1, 3:1, 2:1, 3:2, 1:1, 2:3, 1:2, 1:3 or about 1:4 by weight, and useful ranges may be selected between any of these values.

In one embodiment the granular composition comprises
a) the bran and the one or more plant powders in a ratio of from about 4:1 to about 1:3 by weight, the bran and the one or more saccharides in a weight ratio of from about 5:1 to about 1:2 by weight, and the one or more plant powders and the one or more saccharides in a ratio of from about 5:1 to about 1:1 by weight, or
b) the bran and the one or more plant powders in a ratio of from about 4:1 to about 1:3 by weight, the bran and the one or more saccharides in a ratio of from about 3:1 to about 1:1 by weight, and the one or more plant powders and the one or more saccharides in a ratio of from about 5:1 to about 1:1 by weight, or
c) the bran and the one or more plant powders in a ratio of from about 4:1 to about 1:3 by weight, the bran and the one or more saccharides in a ratio of from about 5:1 to about 1:2 by weight, and the one or more plant powders and the one or more saccharides in a ratio of from about 3:1 to about 1:1 by weight, or
d) the bran and the one or more plant powders in a ratio of from about 4:1 to about 1:3 by weight, the bran and the one or more saccharides in a ratio of from about 3:1 to about 1:1 by weight, and the one or more plant powders and the one or more saccharides in a ratio of from about 3:1 to about 1:1 by weight, or
e) the bran and the one or more plant powders in a ratio of from about 2:1 to about 1:2 by weight, the bran and the one or more saccharides in a weight ratio of from about 5:1 to about 1:2 by weight, and the one or more plant powders and the one or more saccharides in a ratio of from about 5:1 to about 1:1 by weight, or
f) the bran and the one or more plant powders in a ratio of from about 2:1 to about 1:2 by weight, the bran and the one or more saccharides in a weight ratio of from about 3:1 to about 1:2 by weight, and the one or more plant powders and the one or more saccharides in a ratio of from about 5:1 to about 1:1 by weight, or
g) the bran and the one or more plant powders in a ratio of from about 2:1 to about 1:2 by weight, the bran and the one or more saccharides in a weight ratio of from about 5:1 to about 1:2 by weight, and the one or more plant powders and the one or more saccharides in a ratio of from about 3:1 to about 1:1 by weight, or
h) the bran and the one or more plant powders in a ratio of from about 2:1 to about 1:2 by weight, the bran and the one or more saccharides in a weight ratio of from about 3:1 to about 1:2 by weight, and the one or more plant powders and the one or more saccharides in a ratio of from about 3:1 to about 1:1 by weight.

In one embodiment the granular composition may additionally comprise a biodegradeable polymer. In one embodiment the biodegradable polymer may comprise a polysaccharide.

In one embodiment the biodegradable polymer may comprise a gum, such as a plant gum or a gum produced by a microorganism. In various embodiments the biodegradable polymer comprises an exopolysaccharide produced by Achromobacter, Acetobacter, Acinetobacter, Agrobacterium, Alcaligenes, Aspergillus, Aureobasidium, Aureomonas, Azotobacter, Bacillus, Beijerinckia, Lactobacillus, Lentinus, Leuconostoc, Mucorales, Pantoea stewartii, Pseudomonas, Rhizobium, Schizophylum, Sclerotium, Serratia, Sinorhizobium, Sphingomonas, Streptococcus, Xanthomonas, Zooglea, or Zymomonas spp. In various embodiments the biodegradable polymer may be selected from the group comprising xanthan gum, agar, alginate, cassia, dammar, pectin, beta-glucan, glucomannan, mastic, chicle, psyllium, spruce gum, gellan gum, acacia gum, guar gum, locust bean gum, carrageenans, gum arabic, karaya gum, ghatti gum, tragacanth gum, konjac gum, tara gum, pullulan or a combination of any two or more thereof.

In another embodiment the biodegradable polymer may comprise a synthetic polysaccharide, for example a synthetic polymer of sucrose. In one embodiment the polysaccharide may comprise Ficoll® polysaccharide.

In one embodiment the granular composition may additionally comprise bile salts.

In one embodiment the granular composition may be in the form of a dough, for example, an extruded dough.

In one embodiment the granular composition may comprise an exterior coating comprising the one or more microorganisms. In one embodiment the exterior coating may comprise a biodegradable polymer, a non-cytotoxic oil, or a biodegradable polymer and a non-cytotoxic oil. Suitable biodegradeable polymers and non-cytotoxic oils for use in the exterior coating may be selected from those described above.

In one embodiment the granular composition may comprise an external protective coating.

In various embodiments the granular composition may comprise about 0.05, 0.1, 0.15, 0.2, 0.25, 0.3, 0.35, 0.4, 0.5, 0.6, 0.7, 0.8, 0.9 or about 1% by weight of the biodegradeable polymer, and useful ranges may be selected between any of these values.

In one embodiment the granular composition comprises

a substrate, and

a layer that at least partially coats the substrate, the layer comprising one or more microorganisms, two or more plant powders, a biodegradable water-absorbent agent, one or more saccharides, and one or more lubricants.

In one embodiment the substrate may comprise a carbonate mineral, a clay granule, a silicate mineral, or an aluminosilicate mineral. In various embodiments the substrate may comprise marble, sand, zeolite, diatomaceous earth or perlite. In one embodiment the substrate comprises a seed.

In various embodiments the granular composition may comprise the layer and substrate in a ratio of about 8:1, 7:1, 6:1, 5:1, 4:1, 3:1, 2:1 or about 1:1 by weight.

In one embodiment the granular composition further comprises a densifier. In one embodiment the densifier comprises a clay. In various embodiments the densifier comprises gypsum, bentonite, talc, sand or silica.

In one embodiment the granular composition comprises a further active. In some embodiments the further active is selected from one or more of an insecticide and a probiotic.

In some embodiments the granular composition comprises a fungicide.

In various embodiments the granular composition may comprise up to about 5, 6, 7, 8, 9, 10, 11, 12, 13, 14, 15, 16, 17, 18, 19, 20, 21, 22, 23, 24 or about 25% by weight moisture and useful ranges may be selected between any of these values.

In various embodiments the granular composition may have a water activity A_{w} of less than about 0.2, 0.3, 0.4, 0.45, 0.46, 0.47, 0.48, 0.49, 0.5, 0.51, 0.52, 0.53, 0.54, 0.55, 0.56, 0.57, 0.58, 0.59, 0.6, 0.65, 0.66, 0.67, 0.68, 0.69, 0.7, 0.75, 0.8, 0.9, 0.95, 0.98, or about 0.99, and useful ranges may be selected between any of these values. In a preferred embodiment the granular composition has a water activity of less than about 0.55.

In various embodiments the granular composition may comprise at least about 10¹¹, 5×10¹⁰, 10¹⁰, 5×10⁹, 2×10⁹, 10⁹, 5×10⁸, 10⁸, 5×10⁷, 10⁷, 5×10⁶, 10⁶, 5×10⁵, 10⁵ or 10⁴, 10³ or 10² colony forming units (cfu) of the one or more microorganisms per gram of the composition after about 1, 2, 3, 4, 5, 6, 7 days, or 2, 3, 4, 5, 6, 7, 8, 9, 10 weeks storage, or 3, 4, 5, 6, 7, 8, 9, 10, 11, 12, 15, 18, 24 months storage of the composition at a temperature of about 4, 8, 10, 15, 16, 20, 25 or about 30° C. or at ambient temperature, and useful ranges may be selected between any of these values.

In various embodiments the one or more microorganisms may retain at least about 0.1, 0.2, 0.5, 0.75, 2, 5, 10, 15, 20, 25, 30, 35, 40, 50, 55, 60, 65, 70, 75, 80, 85, 90, 95, 98, 99 or 100% viability after 1, 2, 3, 4, 5, 6, 7 days, or 2, 3, 4, 5, 6, 7, 8, 9, 10 weeks, or 3, 4, 5, 6, 7, 8, 9, 10, 11, 12, 15, 18, 24 months storage of the composition at a temperature of about 4 to about 20° C.

In various embodiments the number of viable units of the one or more microorganisms in the composition after about 1, 2, 3, 4, 5, 6, 7 days, or 2, 3, 4, 5, 6, 7, 8, 9, 10 weeks, or 3, 4, 5, 6, 7, 8, 9, 10, 11, 12, 15, 18, 24 months storage of the composition at a temperature of about 4, 8, 10, 15, 16, 20, 25 or about 30° C. or at ambient temperature, is about 50, 60, 70, 75, 80, 90, 95, 100, 110, 120, 125, 150, 175, 200, 225, 250, 275, 300, 350, 400, 450, or about 500% of the amount in the freshly prepared composition, and useful ranges may be selected between any of these values.

In various embodiments, the composition may have a hardness (the maximum load to crush) of at least about 0.5, 1, 1.5, 2, 3, 4, 5, 7.5, 10, 15, 20, 25, 30, 35, 40 or about 50 N, and useful ranges may be selected between any of these values, for example, from about 1 to about 50, 2 to about 50, about 2 to about 30, about 2 to about 20, about 2 to about 10, about 2 to about 5, about 3 to about 50, about 3 to about 30, about 3 to about 20, about 3 to about 10, about 3 to about 5, about 4 to about 50, about 4 to about 30, about 4 to about 20, about 4 to about 10, about 4 to about 5 N, about 5 to about 50 N, about 5 to about 40 N, about 10 to about 50 N, about 10 to about 40 N, about 10 to about 30 N, about 15 to about 50 N, about 15 to about 40 N, about 15 to about 30 N, about 20 to about 50 N, about 20 to about 40 N, or about 20 to about 30 N.

In various embodiments the composition may have a mean diameter of about 0.1, 0.2, 0.3, 0.4, 0.5, 0.6, 0.7, 0.8, 0.9, 1, 2, 3, 4, 5, 6, 7, 8, 9 or 10 mm, and useful ranges may be selected between any of these values.

In some embodiments the granular composition is formed by extrusion.

In some embodiments the granular composition is formed by wet granulation.

In one embodiment the method comprises extruding the dough to form an agricultural composition.

In one embodiment the method may comprise sterilising one or more of the bran, one or more plant powders, a biodegradable water-absorbent agent, one or more saccharides, one or more lubricants, or a combination of any two or more thereof. In one embodiment the sterilising may be achieved using gamma irradiation.

In one embodiment the method may comprise drying the agricultural composition. In one embodiment the agricultural composition may be dried until the composition has a water activity of less than about 0.2, 0.25, 0.3, 0.4, 0.5, 0.6, 0.7, 0.75, 0.8, 0.9, 0.95, 0.98, or about 0.99, and useful ranges may be selected between any of these values.

In one embodiment the method comprises

extruding the dough to form an extruded material, and

processing the extruded material into granules to form an agricultural composition.

In another embodiment the composition comprising one or more microorganisms may comprise one or more saccharides listed above.

In various embodiments the granular composition is applied to soil to
a) kill or control pests, such as insect pests, or
b) reduce the population of a pest, such as an insect pest, or
c) maintain or increase plant or crop growth, or
d) maintain or increase pasture production, or
e) maintain or increase plant, crop or pasture yield, or
f) deliver probiotics to grazing animals or livestock, or bioremediate the soil, or
g)
h) a combination of any two or more of a) to g).

In various embodiments the granular composition of the invention is used to control pests, preferably insect pests.

In various embodiments the granular composition of the invention is used to maintain or increase plant growth.

In various embodiments the granular composition of the invention is used to maintain or increase pasture production.

In various embodiments the granular composition may be applied to substantially cover a crop field or pasture.

In various embodiments the composition may be applied to the soil at a rate of at least about 5, 10, 20, 30, 35, 40, 45, 50, 55, 60, 65, 70, 75, 80, 85, 90, 95, 100, 110, 120, 130, 140, 150, 160, 170, 180, 190 or about 200 kg per hectare, and useful ranges may be selected between any of these values.

In various embodiments the composition may be applied to the soil at a rate of at least about 1×10⁹, 1×10¹⁰, 5×10¹⁰, 1×10¹¹, 5×10¹¹, 1×10¹², 2.5×10¹², 5×10¹², 7.5×10¹², 1×10¹³, 2.5×10¹³, 5×10¹³, 7.5×10¹³, 1×10¹⁴, 2.5×10¹⁴, 5×10¹⁴, 7.5×10¹⁴, or about 1×10¹⁵ cfu of the one or more microorganisms per hectare and useful ranges may be selected between any of these values.

In one embodiment the granular composition may be applied when the soil is wet, or after irrigation or rainfall.

In one embodiment application of the composition may reduce the population of a pest, for example Porina or black beetles, by at least about 10, 15, 20, 25, 30, 35, 40, 45, 50, 55, 60, 65, 70, 75, 80, 85, 90, 95 or 100% in the 4 months following application, and useful ranges may be selected between any of these values.

In one embodiment application of the composition leads to one or more of maintained or increased plant growth, maintained or increased pasture growth, maintained or increased plant yield, maintained or increased pasture yield, or a combination of any two or more thereof.

In various embodiments, application of the composition may increase pasture dry matter production by at least about 5, 10, 20, 30, 40, 50, 60, 70, 80, 90, 100, 150, 200, 250 or 300%, and useful ranges may be selected between any of these values.

In various embodiments the one or more microorganisms in the composition may retain at least about 0.1, 0.2, 0.5, 0.75, 2, 5, 10, 15, 20, 25, 30, 35, 40, 50, 55, 60, 65, 70, 75, 80, 85, 90, 95, 98, 99 or 100% viability about 1, 2, 3, 4, 5, 6, 7 days, or 2, 3, 4, 5, 6, 7, 8, 9, 10 weeks, or 3, 4, 5, 6, 7, 8, 9, 10, 11, 12, 15, 18, 24 months after application of the composition to the soil, and useful ranges may be selected between any of these values.

In various embodiments the number of viable units of the one or more microorganisms in the composition increases by at least about 1.2, 1.25, 1.5, 1.75, 2, 2.5, 3, 3.5, 4, 4.5, 5, 6, 7 or 8 log increase about 1, 2, 3, 4, 5, 6, 7 days, or 2, 3, 4, 5, 6, 7, 8, 9, 10 weeks, or 3, 4, 5, 6, 7, 8, 9, 10, 11, 12, 15, 18, 24 months after application of the composition to the soil, and useful ranges may be selected between any of these values.

In various embodiments the one or more microorganisms are detectable in the soil for up to about 1, 2, 3, 4, 5, 6, 7, 8, 9, 10 weeks, or 3, 4, 5, 6, 9 or 12 months after application of the composition to the soil.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 is a graph showing the effect of water activity on Yersinia entomophaga survival in standard baits from four independent experiments. Mean CFUs by a_{w}, and their linear trends, estimated from GEE analysis. (Note: Only four trend lines are visible because trend lines of aw=0.6172 and 0.6452 overlap). water activity (a_{w}) of 0.5443 (x), water activity (a_{w}) of 0.5449 (▴), water activity (a_{w}) of 0.6981 (▪), water activity (a_{w}) of 0.6452 (●), water activity (a_{w}) of 0.6172 (♦).

FIG. 2 shows the growth of the bacteria Serratia entomophila, over a duration of 96 hours after placement on dampened tissue paper at an initial loading of 1.03×10⁹ (♦), 1.59×10⁶ (▪) and 7.33×10⁴ (▴).

FIG. 3 shows the growth of the bacteria Yersinia entomophaga, over a duration of 96 hours after placement on dampened tissue paper at an initial loading of 1.65×10⁷ (▪), 3.50×10⁵ (▴), 1.73×10³ (●) and 1.72×10⁷ (⋄).

FIG. 4 shows the growth of the bacteria Serratia proteamaculans, over a duration of 96 hours after placement on dampened tissue paper at an initial loading of 7.33×10⁸ (♦), 8.90×10⁵ (▪) and 2.78×10⁷ (▴).

FIG. 5 shows baits viewed by scanning electron microscopy: A) extruded bait having high bacterial loading; B) extruded bait having low bacterial loading; C) wet granulated bait; D) blinding sand coated bait; E) extruded bait having cylindrical shape; F) extruded bait having star shape; G) extruded bait comprising 25:75 talc: bait dough; H) extruded bait comprising 50:50 talc: bait dough.

FIG. 6 shows the proportion of porina larvae (%) that had consumed baits comprising Yersinia entomophaga (YE) or Metarhizium anisopliae var anisopliae (F178) (Met) after 24 (black bars), 48 (light grey bars) and 96 hours (dark grey bars). Control baits contained no microorganisms.

FIG. 7 shows the mortality of porina larvae exposed to baits comprising A) Yersinia entomophaga (YE) or B) Metarhizium anisopliae var anisopliae (F178) (Met) over 47 days. Control baits contained no microorganisms.

FIG. 8 shows the mortality of black beetles exposed to baits comprising Yersinia entomophaga (YE) over 15 days.

### DETAILED DESCRIPTION OF THE INVENTION

The present invention relates to a granular composition, methods of preparing the granular composition, and application of the granular composition on to soil. The granular composition comprises one or more microorganisms, two or more plant powders and a biodegradable water-absorbent agent, for example, a cold water-soluble starch.

The present invention also provides for the delivery of beneficial microorganisms to soil in a composition that supports the viability and or growth of the microorganism during storage of the composition and following application of the composition to the soil. The granular compositions of the invention are suitable for delivery of a wide range of microorganisms to improve soil quality and control pests and disease in plants.

The various embodiments of the composition and methods of the invention have numerous advantages, including but not limited to
attracts target insect pests encouraging ingestion of the microorganism,
improved structural integrity after application to soil and exposure to moisture,
improved shelf life,
growth of microorganism population in composition after application to soil,
improved pesticidal efficacy,
simple and cost-effective to manufacture, and/or
suitable for broadcast application to soil.

### 1. Granular Composition

As used herein the term “granule” and its derivatives (i.e. granular) includes prills, pellets, particles and grains. The granular composition has a mean particle size of at least about 0.1, 0.2, 0.3, 0.4, 0.5, 0.6, 0.7, 0.8, 0.9, 1, 2, 3, 4, 5, 6, 7, 8, 9 or 10 mm, and useful ranges may be selected from between any of these values, (for example, about 0.1 to about 10, about 0.1 to about 8, about 0.1 to about 7, about 0.1 to about 5, about 0.1 to about 4, about 0.1 to about 3, about 0.1 to about 2, about 0.1 to about 1, about 0.2 to about 10, about 0.2 to about 8, about 0.2 to about 6, about 0.2 to about 2, about 0.2 to about 0.8, about 0.2 to about 0.5, about 0.5 to about 10, about 05 to about 7, about 0.5 to about 4, about 0.5 to about 1, about 0.5 to about 0.8, about 0.7 to about 10, about 0.7 to about 9, about 0.7 to about 7, about 0.7 to about 5, about 0.7 to about 3, about 0.7 to about 1, about 0.8 to about 10, about 0.8 to about 9, about 0.8 to about 6, about 0.8 to about 4, about 0.8 to about 1, about 1 to about 10, about 1 to about 8, about 1 to about 7, about 1 to about 5, about 1 to about 3, about 2 to about 10, about 2 to about 8, about 2 to about 6, about 3 to about 10, about 3 to about 7, about 3 to about 5, about 5 to about 10, about 5 to about 8, about 5 to about 7, about 6 to about 10, about 6 to about 8, about 7 to about 10 or about 7 to about 9 mm).

### 1.1 the Granular Composition

The granular composition is formed of one or more microorganisms, such as bacteria and/or fungi, in combination with various excipients.

The granular composition can be formed from a substrate coated with one or more layers comprising a homogenous mix of the one or more microorganisms and excipients. The substrate is a material of sufficient density to provide the composition with suitable ballistic properties to enable effective broadcast distribution of the composition.

Various different types of substrates could be used. For example, the substrate can be selected from a clay, a clay mineral, a seed, a pelletised grain, a granulate or an extruded granule, a carbonate mineral, a silicate mineral, an aluminosilicate mineral, vermiculite, a fertiliser granule, zeolite, diatomaceous earth, perlite, sand or a combination of any two or more thereof.

If a seed, the seed substrate may be an angiosperm, vegetable, legume, cereal or conifer seed. For example, in some embodiments the seed is a spinach, carrot, onion, soybean, lucerne, plantain, brassica, maize, rye grass, canola or clover seed. In various embodiments the substrate may comprise wheat, barley, bran, maize, rye, rice, sorghum, millet, oats, forage brassica, canola or triticale, or a combination of any two or more thereof.

The substrate may contain a fertiliser, for example, a granule of urea, superphosphate, monoammonium phosphate (MAP), diammonium phosphate (DAP, single superphosphate (SSP), triple superphosphate (TSP), calcium ammonium nitrate (CAN) muriate of potash (MOP) or a nitrification inhibitor.

Examples of nitrification inhibitors included dicyandiamide (DCD), N-2,5-dichlorophenyl succinamic acid, 2-chloro-6-trichloromethyl pyridine (“Nitrapyrin”), dicyandiamide (“DCD or “DCDIN””), zinc ethylene-bis-dithiocarbamate, 2,4,6-trichloroaniline, pentachlorophenol, thio-urea, ammonium thiosulphate (ATS), and methylpyrazole phosphates such as 3,4-dimethypyrazole phosphate (DMPP).

As explained above the substrate is coated by one or more layers. The one or more layers partially coats the substrate, or coats all of the substrate, or any amount in between, for example a majority or substantially all of the substrate.

The layers (containing the microorganism and the excipients) comprise about 10, 15, 20, 25, 30, 35, 40, 45, 50, 55, 60, 65, 70 or 75% by weight of the substrate, and useful ranges may be selected from between any of these values, (for example, 10 to about 75, about 10 to about 60, about 10 to about 50, about 10 to about 35, about 10 to about 20, about 15 to about 75, about 15 to about 60, about 15 to about 50, about 15 to about 35, about 15 to about 20, about 20 to about 70, about 20 to about 65, about 20 to about 55, about 20 to about 40, about 20 to about 35, about 20 to about 30, about 25 to about 70, about 25 to about 60, about 25 to about 50, about 25 to about 40, about 30 to about 75, about 35 to about 65, about 35 to about 55, about 35 to about 45, about 40 to about 70, about 40 to about 60, about 40 to about 50, about 45 to about 70, about 45 to about 65, about 45 to about 60, about 55 to about 70, about 60 to about 70% by weight of the substrate).

The granular composition may comprise a binder to facilitate adherence of the coating to the substrate. In one embodiment the binder comprises a polymeric compound. In various embodiments the binder comprises a polyhydroxyl compound, a copolymer of a C₁-C₆ alkyl substituted with one or more lactams, a starch, a protein, a saccharide, or a combination of any two or more thereof.

The binder can be selected from a polyvinyl alcohol, or a cold-water soluble starch or a pre-gelatinised starch, or a combination thereof.

In some embodiments the binder comprises sodium starch glycolate, maltodextrin, trehalose, rice powder, potato starch, kibbled wheat, corn grits, honey, cornflour, wheat flour, a polyvinyl pyrrolidone, hydroxymethylpropyl cellulose and polyvinyl alcohols or a combination of any two or more thereof.

In some embodiments of the present invention the granular composition comprises, or consists of, a homogeneous mix of one or more microorganisms and excipients.

The granular composition may comprise an external protective coating. For example, a talc, colloidal silicon dioxide or stearic acid. The external protective layer can act to protect and/or stabilise the granular composition.

In another embodiment the granular composition comprises an outer layer comprising one or more microorganisms, a biodegradeable polymer and a non-cytotoxic oil. For example, in one embodiment the granular composition comprises a homogenous mix of one or more excipients, at least partially coated with a layer comprising one or more microorganisms, a biodegradeable polymer and a non-cytotoxic oil.

### 1.2 Granular Composition Ingredients

Table 1 below sets out the functional excipients for use in the granular composition of the present invention.

It will be appreciated that the granular composition of the invention may be used to deliver any microorganism that is agriculturally, horticulturally or veterinarily useful. For example, the granular composition of the invention may be used to deliver one or more microorganisms that have pesticidal and/or insecticidal activity, that support plant growth, health or development and/or that promote the health of pets or livestock or prevent disease in pets or livestock. For example, to deliver bacterial therapeutics, probiotics or low methane production microbes.

Examples of suitable bacterial therapeutics include the delivery of attenuated pathogenic strains such as Escherichia coli, Salmonella pullorum, Salmonella typhimurium, Clostridium botulinum, Clostridium sporogenes and Mycobacterium paratuberculosis.

Examples of suitable probiotics include Lactobacillus species Bifidobacterium Species, Enterococcus species, Leuconostoc mesenteroides, Pediococcus acidllactici, Sporolactobacillus inulinus, Streptococcus thermophiles and the yeast Saccharomyces cerevisiae.

Examples of suitable low methane production microbes include, Fibrobacter spp., spp., Prevotella bryantii, and Sharpea azabuensis.

Microorganisms that infect plants (e.g. to become endophytic and/or promote growth of the plant) or animal pests or insects (i.e. by killing or inhibiting reproduction or growth of the insect or pest) may be suitable for use in the granular composition of the invention.

The one or more microorganisms may be selected from the group comprising bacteria, yeast, fungi, spores, fungal microsclerotia or a combination of any two or more thereof. If a bacteria, the bacteria may be selected from a gram positive bacteria, gram negative bacteria, or a combination of gram positive and gram negative bacteria.

In one embodiment the one or more microorganisms comprise a probiotic to improve or support the gut health of pets or livestock.

TABLE 1
Functional agents for use in the present formulation

| Functional | | | Concentration |
|---|---|---|---|
| Excipient | Classification | Examples | Range |
| Microorganism | Single or multiple | Bacteria (e.g | 1 × 10⁶-1 × 10¹⁰ |
| | | Yersinia | cfu/g |
| | | entomophaga), | |
| | | spores, fungi, yeast | |
| A biodegradable | Starches, cross- | Potato starch, | 0.05-5% by |
| water-absorbent | linked polymers, or | polyvinylpyrollidone, | weight |
| agent | peat. | sodium alginate, | |
| Densifier | Clays | Gypsum, bentonite | 1-20% by |
| | | | weight |
| Buffering agent | Effervescent | alginic acid, citric | 1-20% by |
| | agents | acid, sodium | weight |
| | | bicarbonate or | |
| | | tartaric acid | |
| Bulking agent | Plant powders, | Rice powder, wheat | 30%-80% by |
| | brans, processed | bran, wheat (e.g. | weight |
| | cereals, starches, | kibbled wheat), corn | |
| | clay | (e.g. corn grits), | |
| | | maltodextrin, | |
| | | gypsum | |
| Microorganism | Biodegradable | Xanthan gum, | trace |
| stabiliser | polymers, e.g. | Ficoll ® | |
| | plant or bacterial | | |
| | gums, synthetic | | |
| | sucrose polymer | | |
| Emulsifier | Non-cytotoxic oils, | Canola oil | trace |
| | e.g. vegetable oils | | |
| Phagostimulant | Plant powders, | rice powder, wheat | 20%-85% by |
| | brans, processed | bran, wheat (e.g. | weight |
| | cereals, starches, | kibbled wheat), corn | |
| | saccharides | (e.g. corn grits), | |
| | | maltodextrin, | |
| | | honey, sucrose | |
| Insecticide | Carbamates, | Carbaryl, | 0.1-10% or |
| | organophosphates, | chlorpyrifos, | <1% by weight |
| | pyrethroids, | cypermethrin, | |
| | neonicotinoids, | imidacloprid, | |
| | benzoyl phenyl | diflubenzuron | |
| | ureas | | |
| Lubricant | Lipids, fatty acid | Magnesium | 0.05-1% by |
| | esters, minerals, | stearate, talc, silica | weight |
| | inorganic | | |
| | materials, | | |
| | polymers | | |
| CO₂ -generating | food acids, acid | citric acid, tartaric | 0.01-5% by |
| agent | anhydrides, | acid, succinic | weight |
| | carbonates | anhydride, sodium | |
| | | bicarbonate, | |
| | | potassium | |
| | | carbonate | |

The microorganisms can be selected from bacteria such as, for example, Serratia (for example, Serratia entomophilia or Serratia proteomaculans), Xanthamonas, Pseudomonas, Rhizobium, Bifidobacterium, Lactobacillus, Streptococcus (Enterococcus), Yersinia (for example, Yersinia entomophaga), Pseudomonas, Bacillus, Pasteuria, Azobacter, Enterobacter, Azospirillum, Cyanobacteria, Paecilomyces, Streptomycetes, Chromobacterium, Rhanella, Burkholderia, Paenibacillus, Collimonas, Sinorhizobium, Pantoea, Lecanicillum, Erwinia, Pediococus, Leuconostoc, Aeromonas, Neptunomonas, Klebsiella, Ponchonia, Brevibacillus, Acinetobacter or a combination of any two or more thereof.

The microorganisms can be selected from fungi such as, for example, Beauveria, Penicillium, Metarhizium, Trichoderma, Gliocladium, Coniothyrium, Verticillium, Sclerotinia or a combination of any two or more thereof.

In one embodiment the microorganism is an Enterobacteriaceae species. In a specially contemplated embodiment the microorganism is Yersinia entomophaga.

In one embodiment, in granular compositions comprising gram negative bacteria, the agricultural composition comprises bile salts. For example, in various embodiments the composition comprises about 0.02%, 0.025%, 0.03%, 0.04%, 0.05%, 0.06%, 0.07% or about 0.075% by weight bile salts, and useful ranges may be selected from between any of the values, for example from about 0.2% to about 0.75% by weight. The inclusion of bile salts in the granular composition inhibits the growth of some non-enteric microorganism species, but does not affect the growth of gram negative bacterial strains (for example, Enterobacteriaceae species).

In certain embodiments the granular composition comprises one or more densifiers. The inclusion of a densifer increases the density of the granular composition to enable effective broadcast distribution of the granular composition.

Suitable materials for use as densifiers in the granular composition of the invention are materials having a bulk density of about 0.2, 0.3, 0.4, 0.5, 0.6, 0.7, 0.8, 0.9, 1, 1.1, 1.2, 1.3, 1.4 or 1.5 g/m³, and useful ranges may be selected between any of these values, (for example, about 0.1 to about 1.5, about 0.1 to about 1.1, about 0.1 to about 0.8, about 0.1 to about 0.7, about 0.2 to about 1.5, about 0.2 to about 1.3, about 0.2 to about 0.8, about 0.3 to about 1.5, about 0.3 to about 1, about 0.4 to about 1.5, about 0.4 to about 1.4, about 0.4 to about 1, about 0.4 to about 8, about 0.4 to about 7, about 0.5 to about 1.5, about 0.5 to about 1.2, about 0.5 to about 1, about 0.5 to about 0.8, about 0.5 to about 0.7, about 0.5 to about 0.6, about 0.6 to about 1.5, about 0.6 to about 1.2, about 0.6 to about 1, about 0.7 to about 1.5, about 0.7 to about 1.1, about 0.8 to about 1.5, about 0.8 to about 1.2, about 0.9 to about 1.5, about 1 to about 1.5, about 1 to about 1.1, about 1.2 to about 1.5 g/m³).

In one embodiment the densifier comprises a clay. In various embodiments the densifier comprises gypsum, bentonite, sand, silica or talc, or a combination thereof.

It is desirable that the granular composition maintains its structural integrity for a suitable period after application to soil. For example, in an embodiment of the invention in which the granular composition delivers one or more insecticidal microorganisms, the granular composition retains its structural integrity for a period sufficient to allow insect pests to ingest a sufficient amount of the granular composition to deliver an insecticidal quantity of the one or more microorganisms.

The inclusion of a biodegradable water-absorbent agent in the granular composition provides for water absorption and swelling of the granular composition while preventing disintegration of the granular composition.

The biodegradable water-absorbent agent is selected from one or more of starches, cross-linked polymers, and peat.

In various embodiments the water-absorbent agent is a polymer such as a starch or cross-linked polymer. Examples of suitable starches and cross-linked polymers includes cold-water soluble starch, a pre-gelatinised starch, a cross-linked polymer, or a combination of any two or more thereof. In various embodiments the biodegradable water-absorbent agent may comprise potato starch, peat, rice powder, corn starch, sodium starch glycolate, cellulose, methylcellulose, sodium alginate, polyvinylpyrrolidone, sodium carboxymethyl cellulose, croscarmellose sodium, alginic acid, citric acid, a combination of any two or more thereof. In a preferred embodiment the a biodegradable water-absorbent polymer agent comprises potato starch.

In various embodiments the granular composition may comprise about 0.05, 0.1, 0.2, 0.3, 0.4, 0.5, 0.6, 0.7, 0.8, 0.9, 1, 2, 3, 4, or 5% by weight of the a biodegradable water-absorbent agent, and useful ranges may be selected between any of these values, (for example, about 0.05 to about 5, about 0.05 to about 4, about 0.05 to about 1, about 0.05 to about 0.9, about 0.1 to about 5, about 0.1 to about 4, about 0.1 to about 2, about 0.1 to about 0.6, about 0.3 to about 5, about 0.3 to about, about 0.3 to about 3, about 0.3 to about 1, about 0.5 to about 5, about 0.5 to about 3, about 0.5 to about 1, about 0.6 to about 5, about 0.6 to about 3, about 0.6 to about 0.9, about 0.8 to about 1, about 0.8 to about 5, about 0.8 to about 3, about 0.8 to about 0.9, about 1 to about 5, about 1 to about 4, about 1 to about 3, about 2 to about 5, about 2 to about 4 or about 3 to about 5% by weight).

In some embodiments, the granular composition contains one or more phagostimulants. Suitable phagostimulants are excipients that attract, or at least do not repel, target pests, insects or animals. For example, in an embodiment of the invention wherein the granular composition delivers one or more pesticidal microorganisms, it is desirable that the granular composition comprise excipients that are phagostimulatory to the target pest or insect such that the target pest or insect ingests a sufficient amount of the granular composition to deliver a pesticidal quantity of the one or more microorganisms.

It will be appreciated that suitable phagostimulants for use in the granular composition of the invention may be selected to achieve optimal attraction or phagostimulation of the particular target pest, insect or animal to the granular composition.

The phagostimulants are selected from the group comprising one or more plant powders, one or more brans, one or more processed cereals, one or more starches, one or more saccharides, and a combination of any two or more thereof.

In some embodiments the presence of a sugar, such as honey, is used as a phagostimulant. While not intended to be limiting, phagostimulation may be provided by the glucose and fructose.

In some embodiments the granular composition contains one or more bulking agents. It is desirable that the bulking agents promote the viability or growth of one or more microorganisms in the granular composition after application of the granular composition to soil.

The bulking agents suitable in the invention are selected from the group comprising brans, plant powders, saccharides, starches, processed cereals, clays, and a combination of any two or more thereof.

In various embodiments the granular composition may comprise about 5, 10, 15, 20, 25, 30, 35, 40, 45, 50, 55, 60, 65, 70, 75, 80 or about 85% by weight of the one or more processed cereals, and useful ranges may be selected between any of these values (for example, about 5 to about 85, 5 to about 60, about 5 to about 40, about 5 to about 30, about 10 to about 85, about 10 to about 60, about 10 to about 50, about 10 to about 40, about 15 to about 85, about 15 to about 60, about 15 to about 45, about 20 to about 85, about 20 to about 60, about 20 to about 55, about 20 to about 40, about 25 to about 85, about 25 to about 60, about 25 to about 45, about 30 to about 85, about 30 to about 60, about 30 to about 50, about 35 to about 85, about 35 to about 60, about 35 to about 55, about 40 to about 85, about 40 to about 60, about 45 to about 85, or about 45 to about 60% by weight).

In various embodiments the granular composition comprises the bran and the one or more other plant powders in a ratio of about 8:1, 7:1, 6:1, 5:1, 4:1, 3:1, 2:1, 3:2, 1:1, 2:3, 1:2, 1:3 or about 1:4 by weight, and useful ranges may be selected between any of these values (for example, from 8:1 to about 1:4, about 8:1 to about 1:2, about 8:1 to about 3:2, about 8:1 to about 4:1, about 7:1 to about 1:4. 7:1 to about 1:2, about 7:1 to about 1:1, about 7:1 to about 3:1, about 7:1 to about 5:1, about 6:1 to about 1:4, about 6:1 to about 2:3, about 6:1 to about 1:1, about 6:1 to about 3:1, about 6:1 to about 4:1, about 5:1 to about 1:4, about 5:1 to about 2:3, about 5:1 to about 3:1, about 4:1 to about 1:4, about 4:1 to about 1:2, about 4:1 to about 2:1, about 3:1 to about 1:4, about 3:1 to about 1:2, about 2:1 to about 1:4, about 2:1 to about 1:3, about 3:3 to about 1:4, about 3:2 to about 1:2, about 1:1 to about 1:4, about 1:1 to about 1:2, about 2:3 to about 1:4, about 2:3 to about 1:3, about 1:2 to about 1:4, about 1:2 to about 1:3).

In various embodiments the granular composition comprises the bran and the one or more saccharides in a ratio of about 5:1, 4:1, 3:1, 2:1, 3:2, 1:1, 2:3, 1:2, 1:3, 1:4 or about 1:5 by weight, and useful ranges may be selected between any of these values (for example, about 5:1 to about 1:5, about 5:1 to about 1:5, about 5:1 to about 1:2, about 5:1 to about 3:2, about 5:1 to about 3:1, about 4:1 to about 1:5, about 4:1 to about 1:4, about 4:1 to about 1:2, about 4:1 to about 1:1, about 4:1 to about 2:1. 3:1 to about 1:5, about 3:1 to about 1:3, about 3:1 to about 2:3, about 3:1 to about 1:1, about 2:1 to about 1:5, about 2:1 to about 1:3, about 2:1 to about 2:3, about 3:2 to about 1:5, about 3:2 to about 1:2, about 1:1 to about 1:5, about 1:1 to about 1:4, about 1:1 to about 1:2, about 2:3 to about 1:5, about 2:3 to about 1:3 or about 1:3 to about 1:5).

In various embodiments the granular composition comprises the one or more plant powders and the one or more saccharides in a ratio of about 8:1, 7:1, 6:1, 5:1, 4:1, 3:1, 2:1, 3:2, 1:1, 2:3, 1:2, 1:3 or about 1:4 by weight, and useful ranges may be selected between any of these values.

The plant powders for use in the granular composition include plant powders such as bran powders, flours, rice powders or any combination thereof.

The bran is selected from wheat bran, rice bran, oat bran, barley bran, rye bran, triticale bran, corn (maize) bran, amaranth bran, millet bran, teff bran, quinoa bran, buckwheat bran, sorghum bran or a combination of any two or more thereof. In a preferred embodiment the bran comprises wheat bran.

The plant powder may contain wheat flour, rice powder, oat flour, barley flour, rye flour, triticale flour, corn (maize) flour, amaranth flour, millet flour, teff flour, quinoa flour, buckwheat flour, sorghum flour or a combination of any two or more thereof. In a preferred embodiment the plant powder comprises rice powder or maize flour.

In various embodiments the processed cereals comprises wheat, corn, rice, oats, barley, amaranth, millet, quinoa, sorghum, or buckwheat. For example, in various embodiments the one or more processed cereals may comprise kibbled wheat, puffed wheat, ground corn (corn grits), puffed rice, rolled oats, puffed oats, puffed barley, puffed amaranth, puffed millet, puffed quinoa, puffed sorghum, or puffed buckwheat. In a preferred embodiment the composition additionally comprises kibbled wheat and ground corn.

In some embodiments the granular composition contains a saccharide. The saccharides is selected from monosaccharides, a disaccharides, an oligosaccharides, a polysaccharides, or a sugar product, or a combination of any two or more thereof. In various embodiments the one or more saccharides may comprise glucose, fructose, maltose, sucrose, lactose, trehalose, honey, such as clover honey, molasses, glucose syrup, corn syrup, for example, high fructose corn syrup, golden syrup, treacle, cane sugar, refined sugar, raw sugar, brown sugar, white sugar, maltodextrin, cornflour, wheat flour, or a combination of any two or more thereof.

The saccharides may be in the form of a powder or a liquid such as a syrup, or a combination of a powder and a liquid. For example, in one exemplary embodiment the one or more saccharides may comprise maltodextrin and honey.

In various embodiments the granular composition contains a combination of at least two or more, at least three or more, at least four or more, at least five or more, or at least six or more bulking agents or phagostimulants.

In one embodiment the granular composition contains two or more brans, two or more plant powders and one or more saccharides.

In one exemplary embodiment the granular composition contains kibbled wheat, corn grits, wheat bran, rice powder, maltodextrin, and white sugar. In one embodiment the composition comprises kibbled wheat, corn grits, wheat bran, rice powder and maltodextrin in a ratio of 0.5-2:0.5-2:0.5-2:1-4:0.5-2. In a preferred embodiment the composition comprises kibbled wheat, corn grits, wheat bran, rice powder and maltodextrin in a ratio of about 1:1:1:2:1 by weight.

The granular composition may also contain one or more buffering agents selected from the group comprising alginic acid, citric acid, sodium bicarbonate, tartaric acid and a combination of any two or more thereof.

In various embodiments of the invention the granular composition contains an insecticide. It is desirable that the insecticide does not have a significant adverse effect on the viability or growth of one or more microorganisms in the granular composition before or after application of the granular composition to soil. Examples of suitable insecticides include carbamate, an organophosphate, a pyrethroid, a neonicotinoid, or a benzoyl phenyl urea or a combination of any two or more thereof. In various embodiments the insecticide comprises carbaryl, furathiocarb, methmyl, oxamyl, pirimicarb, chlorpyrifos, diazinon, dichlorvos, dimethoate, fenitrothion, maldison, methamidophos, phorate, terbufos, trichlorfon, cypermethrin, deltamethrin, fenvalerate, cyhalothrin, fluvalinate, clothianidin, imidacloprid, thiamethoxam, diflubenzuron, poncho, spinosad or a combination of any two or more thereof. For example, in one embodiment the granular composition comprises bacteria and an insecticide. In one embodiment the granular composition comprises bacteria and an organophosphate insecticide. In one embodiment the granular composition comprises Yersinia entomophaga and an insecticide. In one embodiment the granular composition comprises Yersinia entomophaga and an organophosphate insecticide. In one exemplary embodiment the granular composition Yersinia entomophaga and chlorpyrifos.

In some embodiments the granular composition comprises one or more CO₂-generating agents. It is desirable that the CO₂-generating agent acts to enhance the attraction of the target insect pest to the granular composition by generating CO₂, an insect attractant, when the bait contacts water. Examples of suitable CO₂-generating agents include food acids, acid anhydrides or carbonates or a combination of any two or more thereof. In various embodiments the CO₂-generating agent comprises citric acid, tartaric acid, malic acid, succinic anhydride, sodium bicarbonate, sodium carbonate, potassium bicarbonate, potassium carbonate, or a combination of any two or more thereof.

### 2. Granular Composition Properties

As stated above, the granular composition is in the form of granules and may also be termed prills, pellets, particles, grains or the like.

The granular composition can have a variety of shapes. For example, the granular composition may be more spherical when manufactured by granulation. The shape of the granular composition can also be elongate (i.e. “pellet-shaped”). For example, the granular composition may be pellet-shaped when formed by extrusion. It will be appreciated that the shape of the extruded granular composition will relate to the shape of the extruder die.

The mean diameter of the granular material is about 0.1, 0.2, 0.3, 0.4, 0.5, 0.6, 0.7, 0.8, 0.9, 1, 2, 3, 4, 5, 6, 7, 8, 9 or 10 mm, and useful ranges may be selected between any of these values (for example, about 0.1 to about 10, about 0.1 to about 8, about 0.1 to about 5, about 0.1 to about 3, about 0.1 to about 1, about 0.2 to about 10, about 0.2 to about 9, about 0.2 to about 7, about 0.2 to about 30.2 to about 1, about 0.2 to about 0.5, about 0.3 to about 10, about 0.3 to about 9, about 0.3 to about 5, about 0.3 to about 1, about 0.3 to about 0.8, about 0.3 to about 0.6, about 0.4 to about 10, about 0.4 to about 8, about 0.4 to about 6, about 0.4 to about 5, about 0.4 to about 1, about 0.4 to about 0.6, about 0.5 to about 10, about 0.5 to about 8, about 0.5 to about 7, about 0.5 to about 6, about 0.5 to about 2, about 0.5 to about 0.8, about 0.6 to about 10, about 0.6 to about 9, about 0.6 to about 6, about 0.6 to about 4, about 0.6 to about 1, about 0.7 to about 10, about 0.7 to about 8, about 0.7 to about 6, about 0.7 to about 5, about 0.7 to about 0.9, about 0.8 to about 10, about 0.8 to about 8, about 0.8 to about 7, about 0.8 to about 2, about 0.9 to about 10, about 0.9 to about 6, about 0.9 to about 3, about 1 to about 10, about 1 to about 8, about 1 to about 5, about 2 to about 10, about 2 to about 7, about 2 to about 5, about 3 to about 10, about 3 to about 6, about 3 to about 4, about 4 to about 10, about 4 to about 8, about 4 to about 7, about 5 to about 10, about 5 to about 8, about 5 to about 7, about 6 to about 10, about 6 to about 8, about 7 to about 10 mm).

Given that the granular material may have an irregular shape, it will be appreciated that the reference to a mean diameter is in respect to a notional circular shape. For example, if the granular composition was square or rectangular in shape, then the diameter would be the notional circle that the vertices of the square or rectangle sat within.

As mentioned above, the granular compositions of the present invention may include a substrate that is coated with the composition containing the microorganism and excipients, or may be formed solely from the microorganism and excipients.

For the granular compositions that do not include a substrate, they have a bulk density of about 0.2 g/cm³ to about 1.5 g/cm³, and useful ranges may be selected between any of these values, (for example, about 0.6 g/cm³ to about 1.5 g/cm³, from about 0.7 g/cm³ to about 1.5 g/cm³, from about 0.8 g/cm³ to about 1.5 g/cm³, from about 0.9 g/cm³ to about 1.5 g/cm³, from about 1 g/cm³ to about 1.5 g/cm³, from about 1.1 g/cm³ to about 1.5 g/cm³, from about 1.2 g/cm³ to about 1.5 g/cm³, or from about 1.3 g/cm³ to about 1.5 g/cm³).

For the granular compositions that do include a substrate, they have a bulk density of about 0.2, 0.5, 0.75, 1, 1.25, 1.5, 1.75 or at least about 2 cm³, and useful ranges may be selected from between any of these values, (for example, from about 0.2 to about 1.5, about 0.5 to about 1.4, about 0.5 to about 1.3, about 0.5 to about 1.2, about 0.5 to about 1.1, about 0.5 to about 1, about 0.5 to about 0.9 or about 0.5 to about 0.8 g/cm³).

The density of the granular composition may be determined using standard methods known in the art. For example, bulk density may be measured as “freely settled” or “poured” density, or “tapped” density.

As discussed above, it is desirable that the granular composition substantially retains its structural integrity after application to the soil and do not readily disintegrate.

The brittleness of the granular composition is determined by measuring the amount of force required to cause the granular composition to disintegrate. Brittleness may be measured using an Instron instrument. The brittleness of the granular composition is about 10, 20, 30, 40, 50, 60, 70, 80, 90 or 100 N and useful ranges may be selected from between any of these values, (for example, about 10 to about 100, about 10 to about 80, about 10 to about 6,0 10 to about 50, about 10 to about 40, about 10 to about 30, about 10 to about 20, about 20 to about 100, about 20 to about 90, about 20 to about 70, about 20 to about 60, about 20 to about 50, about 20 to about 40, about 30 to about 100, about 30 to about 80, about 30 to about 60, about 30 to about 50, about 30 to about 40, about 40 to about 100, about 40 to about 80, about 40 to about 60, about 40 to about 50, about 50 to about 100, about 50 to about 80, about 50 to about 60, about 60 to about 100 or about 60 to about 80 N).

The granular composition of the invention is sufficiently porous wherein such that following absorption of water, there are adequate spaces within the structure of the granular composition for the one or more microorganisms to survive and grow.

The porosity of the granular composition may be measured using scanning electron microscopy (SEM) and by determining the water activity of the granular composition. The porosity of the granular composition is about 1, 100, 200, 300, 400, 500, 600, 700, 800, 900 or 1000 μm, and useful ranges may be selected from between any of these values, (for example, about 1 to about 1000, about, to about 900, about 1 to about 800, about 1 to about 600, about 1 to about 400, about 200 to about 1000, about 200 to about 800, about 200 to about 600, about 200 to about 500, about 300 to about 1000, about 300 to about 700, about 300 to about 600, about 300 to about 500, about 500 to about 1000, about 500 to about 800, about 500 to about 700, about 600 to about 1000, about 600 to about 800, about 700 to about 1000, about 700 to about 800 or about 800 to about 1000 μm).

It is desirable that when the granular composition is exposed to moisture it rapidly takes up water and expands in size (swell).

Swellability is measured by sorption assay. The granular composition is exposed to moisture and the amount of water uptake and volume displacement is measured using macrophotography. The swellability of the granular composition is from about 50, 75, 100, 125, 150, 175, 200, 225, 250, 275 or 300% and useful ranges may be selected from between any of these values, (for example, about 50 to about 300, about 50 to about 250, about 50 to about 225, about 50 to about 200, about 50 to about 125, about 50 to about 100, about 75 to about 300, about 75 to about 275, about 75 to about 200, about 75 to about 150, about 75 to about 100, about 100 to about 300, about 100 to about 250, about 100 to about 225, about 100 to about 175, about 150 to about 300, about 150 to about 275, about 150 to about 250, about 150 to about 200, about 175 to about 300, about 175 to about 275, about 175 to about 250, about 175 to about 200, about 200 to about 300, about 200 to about 275, about 200 to about 250, about 250 to about 300%).

In various embodiments the granular composition may have a water activity of less than about 0.2, 0.25, 0.3, 0.35, 0.4, 0.45, 0.5, 0.55, 0.6, 0.65, 0.7, 0.75, 0.8, 0.85, 0.9, 0.95, 0.99, and useful ranges may be selected between any of these values, (for example, about 0.2 to about 0.99, about 0.2 to about 0.90, about 0.2 to about 0.6, about 0.2 to about 0.5, about 0.3 to about 0.9, about 0.3 to about 0.8, about 0.3 to about 0.6, about 0.35 to about 0.99, about 0.35 to about 0.85, about 0.35 to about 0.7, about 0.35 to about 0.6, about 0.4 to about 0.95, about 0.4 to about 0.90, about 0.4 to about 0.6, about 0.55 to about 0.99, about 0.55 to about 0.85, about 0.55 to about 0.6, about 0.6 to about 0.99, about 0.6 to about 0.95, about 0.6 to about 0.85, about 0.7 to about 0.95, about 0.7 to about 0.8, about 0.8 to about 0.99). In a preferred embodiment the granular composition has a water activity of less than about 0.55.

It will be appreciated by those skilled in the art that the optimal water activity for the granular composition may vary.

In the instance of Yersinia entomophaga a water activity of A_{w}: 0.54 to 0.55 is desired. With respect to Yersinia entomophaga, a range up to 0.69 had a faster decline in viable cell numbers. Water activity (A_{w}) is measured with a dew point meter (Decon devices).

The growth of undesirable fungi in the granular composition of the invention may be limited at higher pH. In various embodiments the composition has a pH of at least about pH 6, pH 6.5, pH 7, pH, 7.5, pH 8, pH 8.5, pH 9, pH 9.5 or about pH 10, and useful ranges may be selected from between any of these values, for example, from about pH 6 to about pH 10 or about pH 7 to about pH 9.

The growth of undesirable bacteria in the granular composition may be limited at an acidic pH. The growth of undesirable fungi in the granular composition may be limited by the addition of a fungicidal agent.

### 3. Granular Composition Manufacture

In various embodiments the composition of the present invention is formed by extrusion. For example, the granular composition of the present invention is formed by admixing a composition comprising one or more microorganisms, two or more plant powders, a biodegradable water-absorbent agent, and one or more lubricants to form a dough, and then processing the dough to form the granular composition.

In various embodiments the lubricants are selected from lipids, fatty acid esters, minerals, inorganic materials and polymers. Examples of specific lubricants include magnesium stearate, talc and silica. In various embodiments the lubricant is present at about 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95 or 1.00% by weight, and useful ranges may be selected from between any of these values (for example, 0.05 to about 1, about 0.05 to about 0.90, about 0.05 to about 0.65, about 0.05 to about 0.50, about 0.05 to about 0.40, about 0.05 to about 0.30, about 0.10 to about 1, about 0.10 to about 0.85, about 0.10 to about 0.75, about 0.10 to about 0.65, about 0.10 to about 0.40, about 0.25 to about 1.00, about 0.25 to about 0.75, about 0.25 to about 0.65, about 0.25 to about 0.35, about 0.30 to about 1.00, about 0.30 to about 0.60, about 0.30 to about 0.50, about 0.45 to about 1.00, about 0.45 to about 0.80, about 0.45 to about 0.70, about 0.45 to about 0.60, about 0.65 to about 1.00, about 0.65 to about 0.90, about 0.65 to about 0.75, about 0.70 to about 1.00, about 0.70 to about 0.90, about 0.70 to about 0.80, about 0.85 to about 1.00 or about 0.85 to about 0.95% by weight).

The ingredients and excipients are typically mixed, for example in a suitable mixing vessel such as a blender.

In some embodiments the mixed ingredients and/or excipients are reduced in particle size. For example, in some embodiments the ingredients and/or excipients are reduced to a particle size of about 10, 100, 200, 300, 400, 500, 600, 700, 800 or 900 μm. Preferably the excipients and/or ingredients are ground to a particle size of less than about 850 μm.

The particle size can then be size selected such as through the use of a sieve. In some embodiments the sieve has a pore opening of about 50, 100, 200, 300, 400, 500, 600, 700, 800, 900, 1000, 1100 or 1200 μm. Preferably the pore opening is about 850 μm.

In some embodiments the mixed composition is then combined with the lubricant and the biodegradable water-absorbent agent.

The microorganism can then be added to the dry mixture to prepare a dough. The microorganism can be added using a mixer for example.

As a specific example to demonstrate this method, a cell suspension of Yersinia entomophaga (in a 0.05 M trehalose solution with 0.18% by weight premium clover honey) can be added to the dry mixture to prepare a dough using a cake mixer at speed “2” for 5-10 min. This provides an effective dough for preparing the composition of the invention.

The dough is then extruded through a die, for example, using a hand extruder or mechanical extruder. Suitable extruders would be known and would be operated in a typical manner. For example, at a pressure of 2 bar.

The extruded dough can then be dried. Various drying methods can be used. For example, the dough could be dried in a laminar flow at 20° C. under ambient humidity. During or after drying the dough can then be broken into small pieces to form the granular composition.

In some embodiments the granular compositions can be further size selected to remove any undesirably fine or large particles.

In some embodiments the granular composition is selected for a size of 0.1, 0.5, 1.0, 1.5, 2.0, 2.5, 3.0, 3.5, 4.5 or 5 mm selecting for a bait size between 1 and 2.8 mm, and useful ranges may be selected from between any of these values (for example, 0.1 to about 5, about 0.1 to about 4, about 0.1 to about 3.5, about 0.1 to about 2.5, about 0.1 to about 1.5, about 0.1 to about 0.5, about 0.5 to about 5, about 0.5 to about 4.5, about 0.5 to about 3, about 0.5 to about 2, about 0.5 to about 1, about 1 to about 5, about 1 to about 4, about 1 to about 2, about 2 to about 5, about 2 to about 4.5, about 2 to about 3.5, about 3 to about 5, about 3 to about 4 mm).

It will be appreciated that various granulation techniques can be used to make the composition of the present invention. For example, the use of wet granulation.

Granulation occurs through the agglomeration or cohesiveness of particles to form larger particles. It will be appreciated that the use of wet granulation is useful in the preparation of a substrate-containing granular composition. In such manufacture the granulation process is used to build up material about the substrate.

Granules are formed using a fluidised powder bed through the addition of a liquid carrier to the fluidised powder bed. The powder particles are wetted by the liquid carrier and aggregate to form wet granules. In various embodiments the granulation process will include a binder to maintain the granules once dry. In some embodiments the binder is selected from sodium starch glycolate, maltodextrin, trehalose, rice powder, potato starch, kibbled wheat, corn grits, honey, cornflour, wheat flour, a polyvinyl pyrrolidone, hydroxymethylpropyl cellulose and polyvinyl alcohols or a combination of any two or more thereof.

In various embodiments the manufacture of the granular composition of the present invention is formed by admixing a composition comprising one or more microorganisms, two or more plant powders, a biodegradable water-absorbent agent to form a dough, and then coating a substrate with the dough to form the granular composition.

In other embodiments of the invention the granular composition is formed by admixing a composition comprising two or more plant powders, a biodegradable water-absorbent agent, and one or more lubricants to form a dough, and then coating the dough with an exterior coating comprising one or more microorganisms to form the granular composition.

In other embodiments of the invention the granular composition is formed by admixing a composition comprising one or more microorganisms, two or more plant powders, a biodegradable water-absorbent agent, and one or more lubricants to form a dough, and then coating the dough with an exterior coating comprising one or more microorganisms to form the granular composition.

In various embodiments one or more of the granular composition excipients are heat treated or gamma irradiated to kill or reduce the amount of undesirable microorganisms in the granular composition.

In one embodiment the method may comprise drying the agricultural composition. In one embodiment the agricultural composition may be dried until the composition has a water activity of less than about 0.2, 0.25, 0.3, 0.4, 0.5, 0.6, 0.7, 0.75, 0.8, 0.9, 0.95, 0.98, or about 0.99, and useful ranges may be selected between any of these values.

In one embodiment the method comprises
extruding the dough to form an extruded material, and
processing the extruded material into granules to form an agricultural composition.

In another embodiment the composition comprising one or more microorganisms may comprise one or more saccharides listed above. In one exemplary embodiment the composition comprising one or more microorganisms comprises trehalose and honey.

In another embodiment the composition comprising one or more microorganisms or the exterior coating may comprise a biodegradable polymer, a non-cytotoxic oil, or a biodegradable polymer and a non-cytotoxic oil.

### 4. Use

The granular composition of the present invention can be applied to plants, pastures, fields or any area to be treated. The granular material can be applied to the surface of the land, onto plants or drilled into the soil. In some embodiments the granular composition of the present invention can be added to animal feed. The granular composition contain one or more microorganisms that are supported in the composition such that upon delivery to plants, pastures and fields, upon contact with water the one or more microorganism multiplies within the granular composition. The microorganism's growth within the granular composition is supported by the ingredients in the granular composition such as the particular plant powders and/or the sugars. Through this method the granular compositions can deliver an effective amount of the microorganism to the area to be treated without the requirement of providing a high microorganism loading in the granular composition since the microorganism can multiple in the granular composition upon delivery to the site of action. This has the advantage of lowering the costs of the granular composition given it is not required to carry a high loading of the microorganism.

The granular composition may be spread by spraying (land or aerial), blowing, spinning or pneumatic application the granular composition such that the granular composition cover 5, 10, 15, 20, 25, 30, 35, 40, 45, 50, 55, 60, 65, 70, 75, 80, 85, 90, 95 or 100% of the plants, field, pasture or area to be treated and useful ranges may be selected between any of these values, (for example, 5 to about 100, about 5 to about 95, about 5 to about 90, about 5 to about 70, about 5 to about 6,0 5 to about 40, about 10 to about 100, about 10 to about 90, about 10 to about 70, about 10 to about 60, about 20 to about 100, about 20 to about 90, about 20 to about 70, about 20 to about 60, about 30 to about 100, about 30 to about 70, about 30 to about 50, about 40 to about 100, about 40 to about 80, about 40 to about 70, about 40 to about 60, about 50 to about 100, about 50 to about 80, about 50 to about 70, about 60 to about 100, about 60 to about 90, about 70 to about 100%).

The granular compositions of the present invention can be spread on a pasture using spreaders carried by trucks, tractors, planes or any other vehicle. To obtain good spreadability the granular compositions have a bulk density that assist spreadability.

In one embodiment the granular composition may be applied when the soil is wet, or after irrigation or rainfall.

An advantage of the present invention is that the granular composition of the present invention have an improved shelf life. The applicants have found that the viability of the microorganisms in the granular composition is maintained or not reduced to non-viable levels during storage of the granular composition for prolonged periods.

For example, the granular composition retains its shelf storage stability when stored at 20° C. for up to 6, 7, 8, 9, 10, 11, 12, 13, 14, 15, 16, 17 or 18 months, and useful ranges may be selected between any of these values, (for example from about 6 to about 18, about 6 to about 17, about 6 to about 15, about 6 to about 12, about 6 to about 8, about 7 to about 18, about 7 to about 17, about 7 to about 15, about 7 to about 12, about 7 to about 10, about 8 to about 18, about 8 to about 16, about 8 to about 14, about 8 to about 12, about 10 to about 18, about 10 to about 17, about 10 to about 15, about 10 to about 13, about 10 to about 11, about 11 to about 18, about 11 to about 15, about 12 to about 18, about 12 to about 14, about 13 to about 18 or about 13 to about 14 months).

After storage of microorganism-containing products it is important that they retain a level of microorganisms such that they retain the viability of the product when used. In relation to the granular composition of the present invention, it retains at least about 1×10², 1×10³, 1×10⁴, 1×10⁵, 5×10⁵, 1×10⁶, 5×10⁶, 1×10⁷, 5×10⁷, 1×10⁸, 5×10⁸, 1×10⁹, 2×10⁹, 1×10⁹, 5×10¹⁰, or 1×10¹¹ colony forming units (cfu's) of the one or more microorganisms per gram of the composition after storage. Therefore, after storage the granular compositions of the present invention retain at least about 0.1, 0.2, 0.5, 0.75, 2, 5, 10, 15, 20, 25, 30, 35, 40, 50, 55, 60, 65, 70, 75, 80, 85, 90, 95, 98, 99 or 100% viability. The storage is for about 1, 2, 3, 4, 5, 6, 7 days, or 2, 3, 4, 5, 6, 7, 8, 9, 10 weeks storage, or 3, 4, 5, 6, 7, 8, 9, 10, 11, 12, 15, 18, 24 months storage of the composition at a temperature of about 4, 8, 10, 15, 16, 20° C. or at ambient temperature, and useful ranges may be selected between any of these values.

As described above, the granular composition of the present invention can be utilised to
a) kill or control pests, such as insect pests or other invertebrate pests, b) reduce the population of a pest, such as an insect pest,
c) maintain or increase plant or crop growth,
d) maintain or increase pasture production,
e) maintain or increase plant, crop or pasture yield, or
f) bio-remediate contaminated land, or
g) a combination of any two or more of a) to f).

In relation to increasing pasture dry matter production, the granular composition of the present invention when used on pasture will advantageously increase pasture dry matter production by at least about 5, 10, 20, 30, 40, 50, 60, 70, 80, 90, 100, 150, 200, 250 or 300% and useful ranges may be selected between any of these values, (for example, from about 5 to about 300, about 5 to about 200, about 5 to about 150, about 5 to about 100, about 5 to about 80, about 5 to about 70, about 5 to about 50, about 5 to about 30, about 10 to about 300, about 10 to about 200, about 10 to about 100, about 10 to about 60, about 20 to about 300, about 20 to about 250, about 20 to about 150, about 20 to about 80, about 20 to about 50, about 30 to about 300, about 30 to about 250, about 30 to about 200, about 30 to about 150, about 30 to about 100, about 40 to about 300, about 40 to about 200, about 40 to about 100, about 50 to about 300, about 50 to about 150, about 50 to about 100, about 60 to about 300, about 60 to about 250, about 60 to about 100, about 80 to about 300, about 80 to about 100, about 100 to about 300, about 100 to about 250, about 100 to about 200 or about 150 to about 300%).

As mentioned the granular composition of the present invention can be used to kill or reduce the population of insect pests or invertebrate pests such as grubs, beetles, caterpillars, weevils, snails, slugs, crickets, termites, or ants. In various embodiments the insect pest is beetle larvae, such as grass grubs, chaffers, Torito (Diloboderus abderus), Corbie grubs (Oncopera intricate), Winter Corbie grubs (Oncopera rufobrunnea), Tasmania grass grubs (Acrossidius tasmaniae), weevils such as clover root weevils (Sitona lepidus), adults beetles such as black beetles. Leipdopterans such as Cuncunilla negra, Dalaca pallens, True armyworm (Mythimna unipuncta), African armyworm (Spodoptera exempta), greasy cutworm (Agrotis ipsilon), Cosmopolitan armyworm (Mythimna separate), corn rootworms (Diabrotica), wire worms (Elateridae), other insects pests such as locust (locusta migratoria) or a combination of any two or more thereof.

In one particularly contemplated embodiment, application of the granular composition may kill or reduce the population of Porina, such as Wiseana spp. including Wiseana cervinata, Wiseana copularis, Wiseana fuliginea, Wiseana jocosa, Wiseana mimica, Wiseana umbraculata or Wiseana signata. In another particularly contemplated embodiment the granular composition may kill or reduce the population of black beetles (Heteronychus arator).

For example, application of the granular composition may reduce the population of a pest, for example Porina or black beetles, by at least about 10, 15, 20, 25, 30, 35, 40, 45, 50, 55, 60, 65, 70, 75, 80, 85, 90, 95 or 100% in the four months following application, and useful ranges may be selected between any of these values, (for example, from about 10 to about 100, about 10 to about 90, about 10 to about 75, about 10 to about 60, about 10 to about 50, about 10 to about 40, about 20 to about 100, about 20 to about 90, 20 to about 75, 20 to about 60, 20 to about 50, 20 to about 40, 40 to about 100, 40 to about 90, 40 to about 75, 40 to about 60, 40 to about 50, 50 to about 100, 50 to about 90, 50 to about 75, 50 to about 60, 60 to about 100, 60 to about 90, 60 to about 75, 75 to about 100, 75 to about 90, or from about 75 to about 80%).

The granular composition of the present invention can be used to deliver a wide variety of organisms, and may be used in combination to deliver other compounds such as probiotics.

As one example, the granular composition of the present invention may be used for bioremediation of soil. For example, the granular composition of the present invention can be applied to affected soil to release the microorganism for colonisation of the affected soil.

When the granular composition of the present invention is used for application to plants, pasture or a field, the granular composition is applied at a rate of at least about 1×10⁹, 1×10¹°, 5×10¹°, 1×10¹¹, 5×10¹¹, 1×10¹², 2.5×10¹², 5×10¹², 7.5×10¹², 1×10¹³, 2.5×10¹³, 5×10¹³, 7.5×10¹³, 1×10¹⁴, 2.5×10¹⁴, 5×10¹⁴, 7.5×10¹⁴, or about 1×10¹⁵ cfu of the one or more microorganisms per hectare and useful ranges may be selected between any of these values, (for example, from about 1×10⁹ to about 1×10¹⁵, about 1×10¹⁰ to about 1×10¹⁴, about 1×10¹¹ to about 1×10¹⁴, 1×10¹² to about 1×10¹⁴, about 1×10¹³ to about 1×10¹⁵, or about 1×10¹³ to about 1×10¹⁴ cfu per hectare).

When a granular composition of the present invention is applied to soil the granular composition is applied at a rate of at least about 5, 10, 20, 30, 35, 40, 45, 50, 55, 60, 65, 70, 75, 80, 85, 90, 95, 100, 110, 120, 130, 140, 150, 160, 170, 180, 190 or about 200 kg per hectare, and useful ranges may be selected between any of these values, (for example, about from 5 to about 200, about 5 to about 170, about 5 to about 160, about 5 to about 120, about 5 to about 90, about 5 to about 80, about 5 to about 70, about 5 to about 30, about 10 to about 200, about 10 to about 180, about 10 to about 140, about 10 to about 100, about 10 to about 90, about 10 to about 80, about 10 to about 70, about 10 to about 50, about 30 to about 200, about 30 to about 180, about 30 to about 170, about 30 to about 150, about 30 to about 140, about 30 to about 110, about 30 to about 90, about 30 to about 80, about 30 to about 70, about 45 to about 200, about 45 to about 180, about 45 to about 150, about 45 to about 110, about 45 to about 100, about 45 to about 90, about 45 to about 80, about 45 to about 70, about 50 to about 200, about 50 to about 160, about 50 to about 120, about 50 to about 100, about 50 to about 80, about 60 to about 200, about 60 to about 170, about 60 to about 160, about 60 to about 140, about 60 to about 120, about 60 to about 100, about 60 to about 90, about 70 to about 200, about 70 to about 180, about 70 to about 160, about 70 to about 140, about 70 to about 120, about 70 to about 110, about 80 to about 200, about 80 to about 190, about 80 to about 150, about 80 to about 120, about 90 to about 200, about 90 to about 170, about 90 to about 150, about 90 to about 150, about 110 to about 200, about 110 to about 150, about 120 to about 200, about 120 to about 160, about 130 to about 200, about 130 to about 180 or about 130 to about 170 kg per hectare).

In various embodiments the one or more microorganisms in the composition may retain at least about 0.1, 0.2, 0.5, 0.75, 2, 5, 10, 15, 20, 25, 30, 35, 40, 50, 55, 60, 65, 70, 75, 80, 85, 90, 95, 98, 99 or 100% viability about 1, 2, 3, 4, 5, 6, 7 days, or 2, 3, 4, 5, 6, 7, 8, 9, 10 weeks, or 3, 4, 5, 6, 7, 8, 9, 10, 11, 12, 15, 18, 24 months after application of the composition to the soil, and useful ranges may be selected between any of these values for example, from about 40 to about 100%, about 60 to about 100%, about 70 to about 100% or from about 80 to about 100%.

In various embodiments the number of viable units of the one or more microorganisms in the composition increases by at least about 1.2, 1.25, 1.5, 1.75, 2, 2.5, 3, 3.5, 4, 4.5, 5, 6, 7 or 8 log increase about 1, 2, 3, 4, 5, 6, 7 days, or 2, 3, 4, 5, 6, 7, 8, 9, 10 weeks, or 3, 4, 5, 6, 7, 8, 9, 10, 11, 12, 15, 18, 24 months after application of the composition to the soil, and useful ranges may be selected between any of these values, (for example from about 1.2 fold to about 5 fold, about 1.5 fold to about 4 fold, about 2 fold to about 4 fold or about 2 fold to about 3 fold).

In various embodiments the one or more microorganisms are detectable in the soil for up to about 1, 2, 3, 4, 5, 6, 7, 8, 9, 10 weeks, or 3, 4, 5, 6, 9 or 12 months after application of the composition to the soil.

The invention consists in the foregoing and also envisages constructions of which the following gives examples only and in no way limit the scope thereof.

### EXAMPLES

A number of examples were conducted to examine the stability and manufacture of the baits, as well as the bait's effectiveness in the field, including methods of determining its effectiveness.

Described below is some of the methods common to the examples, such as the growth of Yersinia entomophaga: the bacteria used to examine the efficacy of the baits.

### 1. Porina Preference Assay

Porina larvae were reared from eggs.

For the experimental set up, a click clack container (W 150 mm×L 220 mm×H 60 mm) was filled approximately two-thirds with Hauraki gold Peat Moss and gently shaken so that the surface was level. Tap water was then added to the peat and mixed until the peat was moist. The containers were left overnight to equilibrate.

The following morning six porina larva ˜30 mm in length were placed on top of the peat and allowed to burrow. After the porina larvae had entered the peat profile, four small piles of baits that were visually equal in size were placed on the peat surface. Each sample was tested at least three independent times with one sample per container but in a randomised design. Data from visual assessments by photography were recorded on the basis of the amount of sample that had been disturbed, as determined by photographing on a 24-hour basis over a 72 hour duration.

### 2. Bioassay of Bait Variants Against Porina Larvae

Individual bait weighing approximately 0.02 g was added to the top of fertilizer-free potting mix placed to a depth of approximately 45 mm in a standard specimen container (measuring 45 mm in diameter by 60 mm in height) that contained one porina larva approximately 25-35 mm in length. The containers were then left at 15° C. for 7 days in a dark incubator (Contherm) and monitored daily for the presence of live or dead larvae. To ensure the burrows that the porina larvae had formed throughout this time period were not damaged, larvae were assessed visually by looking for signs of movement through the sides of the transparent specimen container.

### 3. Statistical Analysis

In all experiments statistically analysed, cells at time=0 are at a value of 100%.

### Fluidised Bed Drier Experiment Water Activity

Because each drying time in each replicated experiment resulted in two or three different water activity values at T₀ (referred to as a_{w} hereafter) and viable bacterial cell count (CFU) was measured at rather different intervals in each experiment, this analysis compared CFU change values from T₀ to T₂₈ day between different water activity values. Each CFU change value was calculated as:

CFU change (cfu/g)=mean CFU at T0−CFU at T28 day

These CFU change values were analysed using a generalised estimating equations (GEE) approach in statistical software SAS version 9.3. The GEE analysis took account of correlation between the duplicated counts, and assumed a negative binomial distribution for all counts through log link function. The a^{w} values were used as a covariate in the GEE analysis—i.e. the model was:

Log^{e} CFU change=a+b×a_{w}

### Bait Water Activity Versus Viable Count Change

Yersinia entomophaga numbers CFUs that were measured during storage periods up to 90 days were analysed using a GEE approach in statistical software SAS version 9.3. The GEE analysis took account of correlation between the duplicated (or triplicated) counts at each sampling time, and assumed group-specific negative binomial distributions through log link function. Five groups were determined based on water activity values at T₀. The CFU change in each group over the period was modelled as a linear trend—i.e. decrease at a constant rate (bⁱ) on the log^{e} scale:

logₑCFU=aᵢ−bᵢ×Days

Then, these decreasing rates were compared between the five water activity groups in the GEE analysis, to statistically test the relationship between the CFU change and a_{w}.

### Example 1—Stability

### 1. Method

The baits were stored at 4 and 20° ambient humidity and the samples were assessed as close as possible to 1 hour, 1 day, 28 days, 60 days and 90 days after production, allowing the stability trend of Yersinia entomophaga to be defined.

Previous stability trials have found the bait to be stable at 4° C. (Table 3), so samples stored at 4° C. were only assessed when required.

Attributes such as hardness, ability to “process”, e.g. extrusion properties, and water content were assessed.

The following composition was tested for stability at 4 and 20° C.

TABLE 2
Composition of bait stability tested at 4 and 20° C.

| | | Amount |
|---|---|---|
| Ingredient | Function | (% w/w) |
| Yersinia entomophaga | Active ingredient | 38.37% |
| suspension with live bacteria | | |
| Kibbled wheat | Porina | 10.12% |
| | phagostimulant | |
| Corn grits | Porina | 10.12% |
| | phagostimulant | |
| San Bran ® plant powder | Porina | 10.12% |
| | phagostimulant | |
| Rice powder | Bait stabiliser | 20.24% |
| Maltodextrin | Bait stabilizer | 10.12% |
| | Porina | |
| | phagostimulant | |
| Xanthan gum | Bacteria stabiliser | 0.23% |
| Canola oil | Bacteria stabiliser | 0.23% |
| Magnesium stearate | Lubricant | 0.13% |
| Premium clover honey | Porina | 0.18% |
| | phagostimulant | |

The bait was manufactured such that the bacteria were incorporated both on the surface of the bait (by spraying) and distributed throughout the bait.

### 2. Results

The stability of the composition of Table 2 is shown below in Table 3.

TABLE 3
Shelf life stability of the composition of Table 2.

| | |
|---|---|
| Time | Viable cell counts (cfu/g) |

| (days) | 4° C. | 20° C. |
|---|---|---|
| 0 | ~10 × 10¹⁰ | 10 × 10¹⁰ |
| 7 | ~10 × 10¹⁰ | 9 × 10¹⁰ |
| 14 | ~10 × 10¹⁰ | 7 × 10¹⁰ |
| 21 | ~10 × 10¹⁰ | 5 × 10¹⁰ |
| 28 | ~10 × 10¹⁰ | 3 × 10¹⁰ |
| 35 | ~10 × 10¹⁰ | 2 × 10¹⁰ |
| 42 | ~10 × 10¹⁰ | 2 × 10¹⁰ |
| 49 | ~10 × 10¹⁰ | 2 × 10¹⁰ |
| 56 | 9 × 10¹⁰ | |
| 63 | 9 × 10¹⁰ | |

### Example 2—Ingredients/Manufacturing Variables

### 1.1 Assessment of Formulation Binders

To determine the effect of potential binders or anti-desiccants in place of Paselli starch, 2% Acacia gum or 1% or 5% oil was included in the dry standard bait ingredient.

The baits prepared with either acacia gum (9.93×10¹) or 1% oil (6.73×10⁴) or 5% oil (7.55×10⁴) were not stable in storage with a significantly reduced shelf life apparent by day 28 compared with the standard bait (3.01×10⁷).

### 1.2 Assessment of Water Activity in “Standard” Bait

From preliminary assessments of data accrued throughout the project it was observed that baits of a low water activity had higher rates of survival than stored standard baits with a higher water activity. For all experiments in this study standard bait was used as an internal control and water activity was always measured as a production variable. This enabled a detailed analysis comparing Yersinia entomophaga survival against water activity.

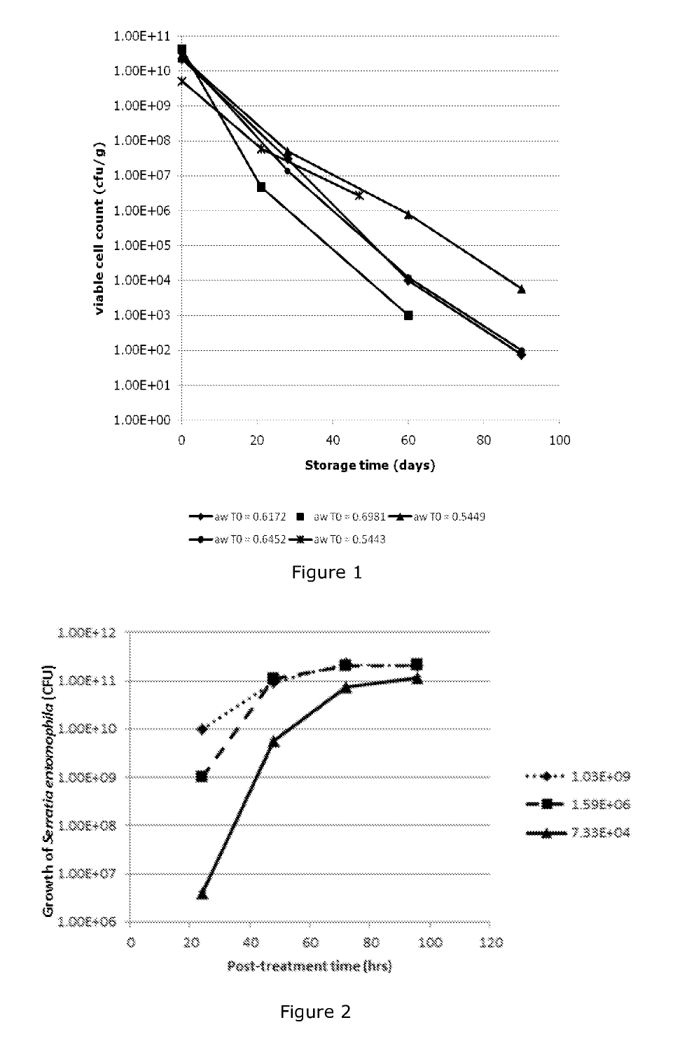

From the GEE analysis it is evident that the rate of decrease (over the course of each experiment) in viable cell numbers was significantly greater as water activity at T₀ increased. As shown in FIG. 1, there was significantly less survival at a_{w} of 0.698, and greater survival at the lower a_{w} of 0.544.

### 1.3 Water Holding Capacity

To determine the ability of various bait components to absorb water, bags were independently filled with each component (as shown in Table 4) and the filled teabag immersed in water under stirring for 1 h to allow for maximum uptake of water. The weight of the material before (“dry weight”) and after water uptake (“wet weight”) was recorded, and corrected for the dry and wet weight of the tea bag. The moisture uptake (swelling) was calculated as % increase in weight.

TABLE 4
Ingredients, its function, percentage (w/w or v/w) in
the undried dough and amount required to prepare 1 kg
of the bait dough for extrusion and coating a core

| | Extruded bait | | | Coated marble | | |
|---|---|---|---|---|---|---|
| | (“Standard”) | | | substrate* | | |
| Ingredient | % | Amount | | % | Amount | |
| Yersinia entomophaga suspension | 35.30 | 550 | mL | 25.18 | 170 | mL |
| Kibbled wheat | 10.70 | 166.7 | g | 12.35 | 83.35 | g |
| Corn grits | 10.70 | 166.7 | g | 12.35 | 83.35 | g |
| San Bran ® plant powder | 10.70 | 166.7 | g | 12.35 | 83.35 | g |
| Rice powder | 21.40 | 333.3 | g | 24.70 | 166.7 | g |
| Maltodextrin | 10.70 | 166.7 | g | 12.35 | 83.35 | g |
| Paselli BC (Potato starch) | 0.30 | 5.2 | g | 0.39 | 2.6 | g |
| Magnesium stearate | 0.13 | 2.0 | g | 0.15 | 1.0 | g |
| Premium clover honey | 0.18 | 2.7 | g | 0.20 | 1.38 | g |

*50:50 substrate to build up ratio

Moisture content of the formulated baits was determined using an oven-drying method and expressed as percentage based on wet weight. One g of bait was withdrawn from an individual bag and dried at 80° C. for 24 h. After 24 h, the dry weight of the sample was recorded and the moisture content calculated as % increase in weight.

Water activity was measured using an Aqualab Water Activity Meter Series 3TE (Decagon Devices).

Bait components varied in its ability to take up water (Table 5). Corn grit increased in weight by 48% through water uptake, kibbled wheat by 91% and bran by 129%.

TABLE 5
Water uptake values of the standard bait and its ingredients.

| | Water | | | | |
|---|---|---|---|---|---|
| Replicate samples | activity | Initial | Soaked | Swelling | average |
| (1 and 2) | (a_{w}) | weight | weight | (%) | % |
| Teabag 1* | | 0.15 | 0.309 | | |
| Teabag 2* | | 0.15 | 0.291 | | |
| Kibbled wheat 1 | | 4.003 | 7.736 | 93.0 | |
| Kibbled wheat 2 | 0.4607 | 4.822 | 9.136 | 89.1 | 91.1 |
| Corn grit 1 | | 4.784 | 7.104 | 46.8 | |
| Corn grit 2 | 0.5103 | 5.276 | 7.93 | 48.8 | 47.8 |
| Rice powder 1 | | 3.54 | 6.102 | 71.2 | |
| Rice powder 2 | 0.5662 | 2.355 | 4.01 | 68.3 | 69.7 |
| San Bran ® 1 plant | | 4.25 | 9.618 | 127.3 | |
| powder | | | | | |
| San Bran ® 2 plant | 0.3571 | 4.003 | 9.15 | 129.7 | 128.5 |
| powder | | | | | |
| Standard bait | | 3.841 | 5.874 | 51.0 | |
| mixture 1 | | | | | |
| Standard bait | 0.4749 | 6.049 | 9.433 | 54.8 | 52.9 |
| mixture A 2 | | | | | |
| Paselli BC (Potato | 0.4958 | | | | |
| starch)** | | | | | |
| Maltodextrin** | 0.4679 | | | | |

*The teabag is the bag that contains the formulation.
**not tested due to the fine nature of component.

Based on the information presented in Table 5, two bait ingredients were identified that differed in water uptake: rice (˜70%) and bran (˜129%). Although corn grits had a lower water sorption (˜48%) than rice, this was a property of its smooth and waxy (hydrophobic surface), limiting its ability to absorb moisture.

### 1.4 Modified Bait Variants

Based on the results of bait physiochemical properties, two new variants were developed by either removing the bait component to be tested or replacing a component such as San Bran® plant powder with a different form of bran (wheat bran) that had different properties (i.e. no sugar). Using the standard bait formulation (see B of Table 10), a bait was made without bran and another without rice powder—in these instances the remaining bulk was made through the addition of extra rice or bran, respectively, to make the final volume. The omission of various components resulted in different physical attributes of the bait, such as its ability to be extruded and broken post-extrusion.

The properties tested are listed in Table 6. Of note, heat-treated bait also assessed at this time, was found to be brittle, while the omission of rice led to a bait that was easy to extrude but was slow to take up moisture. The alteration of bait components also changed the baits' appearance relative to the standard bait.

TABLE 6
Details of variation to the standard bait variants, the
rational and its attributes noted during production

| | | Bait manufacture | Bait |
|---|---|---|---|
| | Rationale | attributes | palatability¹ |
| Standard bait | Reference bait | Reduce cost | YES |
| Heat treated | Reduce microbial | Rapid uptake of | ND |
| | competitors | bacteria concentrate, | |
| | | the dough hard to | |
| | | extrude | |
| pH 8 | Reduce microbial | Nil effect | ND |
| | competitors, the | | |
| | pH is not | | |
| | conducive to | | |
| | fungal growth | | |
| Bile salts | Reduce microbial | Nil effect | ND |
| | competitors; bile | | |
| | salts are not | | |
| | conducive to the | | |
| | growth of non- | | |
| | enterobacteria | | |
| Bacterial load | Determine effect | Nil effect - reduced | ND |
| | of Yersinia | load leads to greater | |
| | entomophaga | survival and | |
| | density dependant | economical | |
| | competition | | |
| Packaging | Determine effect | greater porosity | ND |
| | of gas exchange | leads to greater | |
| | through the use of | survival | |
| | different | | |
| | packaging. | | |
| Replacement of | Determine the | Rapid uptake of | NO |
| plant powder | impact of San | bacteria concentrate | |
| Bran ® with rice | Bran ® plant | and the bait became | |
| powder | powder on | brittle post drying | |
| | absorption and | | |
| | drying | | |
| Replacement of | Determine the | Wet | NO |
| rice powder with | impact of San | | |
| San Bran ® plant | Bran ® plant | | |
| powder | powder on | | |
| | absorption and | | |
| | drying | | |
| Replacement of | Determine | Nil effect | ND |
| rice powder with | influence of | | |
| barley flour | different starch | | |
| | types on dough | | |
| | quality, reduce | | |
| | cost and enhance | | |
| | stability in | | |
| | storage | | |
| Replacement of | Determine | Nil effect | ND |
| rice powder with | influence of | | |
| maize flour | different starch | | |
| | types on dough | | |
| | quality, reduce | | |
| | cost and enhance | | |
| | stability in | | |
| | storage | | |
| Replacement of | Cheaper source | Dough consistency | YES |
| San Bran ® plant | of bran | not uniform and | |
| powder with | | hard to extrude. | |
| wheat bran | | The baits became | |
| | | more brittle | |
| Freeze dried | Alternative | Nil effect | ND |
| standard extruded | production | | |
| bait | method | | |
| Addition of | Determine if | Nil effect | ND |
| acacia | addition of a | | |
| gum into bacterial | polysaccharide | | |
| concentrate | enhances survival | | |
| | of cells during | | |
| | production and | | |
| | storage | | |
| Addition of oil | Reduce potential | Nil effect | ND |
| to the dry | desiccation | | |
| standard | stress to | | |
| bait mixture | Yersinia | | |
| | entomophaga | | |

¹ND = not determined; YES = palatable to Porina; NO = not palatable to Porina.

Along with the standard bait, two baits “standard minus San Bran® plant powder “or standard minus rice powder” were placed in a long term stability trial and assessed periodically for surviving Yersinia entomophaga. Initial data revealed that the standard bait minus rice powder had higher viable cell numbers at day 60 relative to the standard bait and significantly greater than the historic bait. The standard bait without San Bran® plant powder exhibited reduced survival of Yersinia entomophaga. Based on this information no further replicates of this bait were undertaken.

In other instances, such as bait packaging or replacement of San-Bran® plant powder with wheat bran, a favourable storage trend was observed from where further bait batches were produced and placed in a second or third assessment allowing for robust statistical analysis.

Baits where wheat bran was used in place of San Bran® plant powder, resulted in greater than 10-fold higher Yersinia entomophaga survival over 90 days relative to the standard bait (San Bran® plant powder). This was validated by statistical LMM analysis of the data.

### 1.5 Packaging Materials

Physical processes such as gas and moisture transfer can occur through the package containing the bait, which could affect Yersinia entomophaga survival in the stored product. To determine if this might be the case, standard baits were packaged in materials that differed in its gas transfer abilities (Table 7).

Each of the formulations was independently packaged (15 g/bag) in either TGT bags (pore size 120 μm, 10×10 cm), gas transferable (GT) bags (pore size 80 μm thick, 10×10 cm), mesh bags (pore size 280 μm, 10×10 cm) or foil bags (pore size <1 μm, 10×10 cm). The mesh bags are made from commercially sourced screen silk; there is currently no information on either the water or oxygen transmission rate.

The bags were then stored at 4 and 20° C. and ambient humidity. Viable cell counts, water activity and moisture content were assessed after drying of the bait (1 day) and after 28, 60 and 90 days of storage. At each sampling time, one bag was destructively sampled.

TABLE 7
Storage bags and its rate of permeability

| | Water vapour | Oxygen | |
|---|---|---|---|
| Bag | transmission rate | transmission rate | Pore size |
| Foil | 0.4 g/m²/24 h | 0.3 cc/m²/24 h | <1 μm |
| GT | 5 g/m²/24 h | 6000 to 8000 | 80 μm |
| | | cc/m²/24 h | |
| TGT | 2.5 g/m²/24 h | 625 cc/m²/24 h | 120 μm |
| Mesh bag | * | * | 280 μm |

Each % survival value was calculated at each post-storage time as:

% Survival (%)=CFU at each post-storage time/mean CFU at T0×100

The % survival values were analysed using a linear mixed modelling (LMM) approach in statistical software SAS version 9.3. In the LMM analysis, correlation between the duplicated (or triplicated) measurements at each sampling time was modelled as a random effect. In the instance of bait packaging the LMM also included the effects of two factors: packaging (Package) and post-storage measuring time (Day), and its interaction (Package*Day) as fixed effects.

Bait stored in the GT bag over 60 days appeared to have higher numbers of surviving Yersinia entomophaga than when the bacterium was stored in either a TGT or a foil packaged bag.

To validate this, the experiment was repeated and a “mesh” bag was included as an additional treatment. Although at day 60 there appeared to be a consistent trend of improved survival in the more porous bag types (MESH>GT>TGT>FOIL), this was not statistically significant.

### 1.6 Effect of Storage Temperature on Survival of Yersinia in Baits

The initial aim of the project was to achieve 3-month stability at 20° C. where the bacteria count does not go below ˜6×10⁸/g bait. It should be noted that commercial food cool stores are typically maintained in a temperature range of between 6-7° C.

In one experiment the viability of Yersinia entomophaga, in a standard bait in TGT packaging stored at either 20° C. or 10° C., was assessed after 28 and 60 days.

When stored at 10° C. there was less than one log drop in numbers of Yersinia entomophaga, in comparison with a large decrease in numbers in bait stored at 20° C. This indicates that a change in temperature has a significant effect on the survival of Yersinia entomophaga within the bait and that there may be a yet to be determined threshold temperature between 10-20° C., above which the rate of survival of the bacteria in the bait rapidly decreases.

TABLE 8
Viable cells numbers (cfu/g) and water activity values from
extruded standard baits stored at either 10 or 20° C.

| | Temp | | | After 28 | After 60 |
|---|---|---|---|---|---|
| Bait formulation | (° C.) | a_{w} | Initial | days | days |
| 24 h dried | 10 | 0.60 | 7.6 × 10⁹ | 2 × 10⁹ | 5.4 × 10⁸ |
| 24 h dried | 20 | 0.60 | 7.6 × 10⁹ | 2 × 10⁷ | 9.7 × 10⁵ |
| 30 h dried | 10 | 0.47 | 6.0 × 10⁹ | 1 × 10⁹ | 6.2 × 10⁸ |
| 30 h dried | 20 | 0.47 | 6.0 × 10⁹ | 3 × 10⁷ | 2.5 × 10⁵ |

1.7 Yersinia entomophaga Bait Loading

To determine if bacterial loading influences the survival dynamics of Yersinia entomophaga in a bait, a series of standard baits were prepared containing different densities of Yersinia entomophaga, ranging from 10⁵, 10⁷, 10⁸, 10¹⁰ cells per gram of the bait.

After the 28-day shelf storage period, a higher initial bait loading led to a greater rate of cell death. LMM analysis of the 28 day storage data found the logₑ % Survival=3.7171−0.6620×log₁₀ initial loading was a statistically significant (P=0.024) relationship.

TABLE 9
Mean % surviving cells

| Standard bait | Mean % surviving |
|---|---|
| (per g of bait) | cells |
| loading of 10¹⁰ | 0.05 |
| loading of 10⁸ | 0.14 |
| loading of 10⁷ | 0.24 |
| loading of 10⁵ | 1.05 |

### Example 3—Manufacture of Baits

Two different types of baits were tested: extruded baits and baits formed with a coated marble core. The baits with a coated marble core comprised a 50:50 substrate to build up (coating) ratio.

The key ingredients used in the baits and the amount of the key ingredient are shown in Table 4. To determine the ability of various bait components to absorb water, bags were independently filled with each component (as shown in Table 4) and the filled teabag immersed in water under stirring for 1 h to allow for maximum uptake of water. The weight of the material before (“dry weight”) and after water uptake (“wet weight”) was recorded, and corrected for the dry and wet weight of the tea bag. The moisture uptake (swelling) was calculated as % increase in weight.

To determine the ability of various bait components to absorb water, bags were independently filled with each component (as shown in Table 4) and the filled teabag immersed in water under stirring for 1 h to allow for maximum uptake of water. The weight of the material before (“dry weight”) and after water uptake (“wet weight”) was recorded, and corrected for the dry and wet weight of the tea bag. The moisture uptake (swelling) was calculated as % increase in weight.

### 1. Method

### 1.1 Extruded Bait

The ingredients used to prepare the standard extruded bait and their amounts are listed in Table 4.

The excipients were ground in a blender, sieved (850 μm), and mixed together with magnesium stearate and Paselli BC (Potato starch). Yersinia entomophaga cell suspension (in a 0.05 M trehalose solution with 2.7 g premium clover honey) was added to the dry mixture to prepare a dough using a cake mixer at speed “2” for 5-10 min.

The dough was extruded through a 3 mm die using either a hand extruder or mechanical extruder (operated at 2 bar pressure) onto clean plastic trays. The extruded bait dough was dried for 24 h in the laminar flow (with air “on”) at 20° C. under ambient humidity.

Around 3-4 h from the start of the drying process the bait material was broken into small pieces. At the end of the 24 h period, the dried baits were sieved to remove any fine or large particles selecting for a bait size between 1 and 2.8 mm.

### 1.2 Marble Chip Coated Bait

An alternative bait production strategy of coating the standard bait material to a solid dense core (marble chip) was assessed. The resultant bait was assessed in palatability assays and under controlled conditions using a fluidised bed drier.

A technology was developed where the standard bait material is coated onto a solid inert core material. The chosen core was marble chip, as it is a chemically inert and non-porous material that should not influence the dynamics of the applied bait and is unlikely to influence Yersinia entomophaga survival dynamics in the bait matrix.

Given the new production process and the unknown ability of a bait mix to bind to the core material, three formulation binders were independently assessed. These were
2% w/v polyvinyl pyrrolidone (PVP), and
0.3%, Paselli BC (Potato starch).

Marble chips coated with the bait matrix were prepared in a Cimbria CC2 laboratory scale seed coating machine. Screened 1-2 mm marble chips (500 g) were added to the drum and coated with a bait mixture (Table 3) using concentrated Yersinia entomophaga live cells suspended in 0.05M trehalose (170 mL) to bind the coating to the core.

In order to determine optimal moisture contents for storage stability it was necessary to establish a repeatable drying process. A fluidised bed drier allows the rapid assessment of the effects of drying time on the survival dynamics of Yersinia entomophaga in the bait. Heated air is forced up through a porous matrix on which the material to be dried is positioned. The movement of air has the force to uplift the material being dried resulting in a suspended tumbling motion leading to the rapid drying of the test bait material. A fluidised bed drier maintains a constant programmed temperature and humidity can be measured within the chamber.

The marble chip coated baits were transferred to a custom-built fluidised bed dryer. The drying bed was 190 mm in diameter and approximately 30 mm in depth. The marble chip coated baits were dried using air at a flow rate of approximately 1 m/s. Although the inlet air was unheated, the heat produced by the machine resulted in the heating of inlet air to approximately 35° C. Marble chip coated baits were dried for up to 120 minutes with samples collected at 10, 30, 60 and 120 minutes for assessment of water activity and viability (CFU/g).

The water activity (outlined below) of the resultant product at the set time points was determined.

### 2. Results

### 2.1 Marble Chip Coated Bait Development

The resultant PVP baits were smooth in appearance and felt hard. The use of Paselli BC (Potato starch) produced a bait of good consistency and was therefore pursued as a binder for core coating. Of note, approximately 60% of the weight of a 1 g marble chip coated bait was the marble chip core, with the remaining 40% comprised of the standard bait material applied as the coating.

### 2.2 Fluidised Bed Drier Experiment

Tests showed solid cores coated with the standard bait matrix formed discrete free-flowing coated baits that were suitable for fluidised bed drying experiments.

Similar to the assessment of the water activity of extruded standard bait, marble chip coated bait of a lower water activity has a higher rate of survival. This observation combined with that of all other standard extruded bait data where a_{w} was assessed. Water activity at T0 was plotted against Yersinia entomophaga viable cell numbers change after 28 days in storage. Cell viability significantly decreased as water activity increased according to the equation: Log^{e} CFU change=17.9065+5.1106×aw (P<0.0001).

Water activity has a significance influence on the survival of Yersinia entomophaga under storage at 20° C.

### 2.3 Bait Absorption Assay

In this study 1 gram of bait containing Yersinia entomophaga, Serratia entomophila or Serratia proteamaculans was placed, at various cell densities, onto moist paper towels. The samples were destructively assessed and Yersinia entomophaga, Serratia entomophila or Serratia proteamaculans enumerated as outlined above.

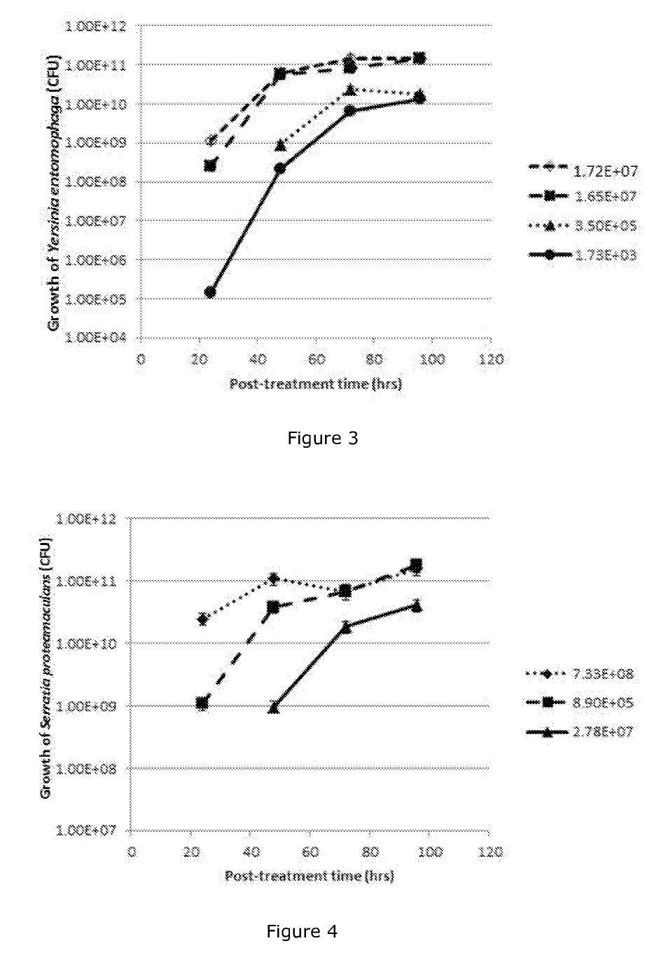

As shown in FIGS. 2-4 the number of bacteria within the bait increased within 20-48 hours. FIG. 2 demonstrates approximately 7-log increase from a loading of 7.33×10⁴ cells/g. FIG. 3 demonstrates an increase approximately 7-log increase from a loading of 1.73×10³ cells/g. FIG. 4 demonstrates approximately 4-log increase from a loading of 8.9×10⁵ cells/g.

### Example 4—Effectiveness of the Bait in the Field

### 1. Method

The effectiveness of baits containing Yersina entomophaga was tested against porina (Wiseana spp).

As shown in Table 10, the baits tested in the preference assay were
a) bait 38% Yersinia
b) standard 35% Yersinia
c) standard (minus rice powder, replaced with San Bran® plant powder)
d) standard (San Bran® plant powder replaced with wheat bran)
e) standard (minus rice powder)
f) standard (minus San Bran® plant powder. replaced with rice powder)
g) marble chip coated with the standard bait material and a clover leaf as a control.

TABLE 10
Composition of the baits tested

| Ingredient/ | | Percentage w/w or w/v | | | | |
|---|---|---|---|---|---|---|
| excipient | Function | A | B | C | D | F |
| Yersinia | active | 38 | 35 | 35 | 35 | 35 |
| entomophaga | | | | | | |
| (MH96) live | | | | | | |
| bacteria | | | | | | |
| Kibbled wheat | Phagostimulant | 10 | 11 | 11 | 11 | 11 |
| Corn grits | Phagostimulant | 10 | 11 | 11 | 11 | 11 |
| San bran | Phagostimulant | 10 | 11 | 32 | 11 | 0 |
| Rice powder | Phagostimulant | 20 | 21 | 0 | 21 | 32 |
| Maltodextrin | Phagostimulant | 10 | 11 | 11 | 11 | 11 |
| Paselli BC (Potato | stabiliser | | 0.3 | 0.3 | 0.3 | 0.3 |
| starch) | | | | | | |
| Magnesium stearate | lubricant | | 0.3 | 0.3 | 0.3 | 0.3 |
| Xanthan gum | stabiliser | 0.12 | 0.13 | 0.13 | 0.13 | 0.13 |
| Canola oil | emulsifier | 0.23 | | | | |
| Premium clover | phagostimulant | 0.23 | 0.18 | 0.18 | 0.18 | 0.18 |
| honey | | | | | | |

A surface coated bait was used as a comparison in all but one replicate, to determine if porina had a greater feeding preference for that bait relative to the other baits. The coated marble chip bait was also used.

The remaining baits assessed had shown improved shelf life characteristics in previous experiments. These were a standard bait with wheat-bran in place of San Bran® plant powder and a standard bait that contained no rice powder.

Where rice powder or san bran was omitted (Group C and Group F), the baits swelled and were not touched by the larvae. These baits were therefore considered not practical to use. In general the other baits that were assessed in the assay were frequently disturbed, indicative of interest by the larvae.

There was significant Porina mortality in treatments containing Yersinia entomophaga baits over the 7-day duration while control treatments showed negligible mortality. The marble chip coated with the standard bait material had reduced efficacy with a delayed 28% mortality at day 7 (Table 11). It should be noted that the bacterial loading of these marble coated baits was low with 1.81×10⁶ CFU/g and this likely reduced efficacy of this treatment.

TABLE 11
Ability of bait variants to cause mortality against Porina larvae.
Values are number of healthy (H) or dead (D) larvae (out of a
total of 14 per treatment) after introduction of the bait.

| | Day 2 | Day 3 | Day 4 | Day 5 | Day 6 | Day 7 |
|---|---|---|---|---|---|---|
| Control | 14 H | 14 H | 14 H | 14 H | 14H | 1D 13H |
| 1) standard | 1D 13H | 4D 10H | 8D 6H | 10D 4H | 13D 1H | 13D 1H |
| 5.86 × 10⁹ | | | | | | |
| CFU/g | | | | | | |
| 2) with bran | 14H | 4D 10H | 7D 7H | 9D 5H | 12D 2H | 12D 2H |
| 7.59 × 10⁹ | | | | | | |
| CFU/g | | | | | | |
| 3) marble | 14H | 14H | 1D 13H | 3D 11H | 4D 10H | 4D 10H |
| 1.81 × 10⁶ | | | | | | |
| CFU/g | | | | | | |

### Examples 5-10

Methods common to Examples 5-10 are described below.

### 1. Manufacture and Composition of Baits

Baits tested in Examples 5-10 were manufactured as follows.

The ingredients used in baits prepared by extrusion, wet granulation and coating on a core of blinding sand and their amounts are listed in Table 12.

TABLE 12
Ingredients, percentage (w/w or v/w) in the undried dough
and amount required to prepare 1 kg of the bait dough for
extrusion, wet granulation or coating a blinding sand core

| | Extruded and wet | | | Coated blinding sand | | |
|---|---|---|---|---|---|---|
| | granulated baits | | | substrate* | | |
| Ingredient | % | Amount | | % | Amount | |
| Bacterial or spore suspension | 35.30 | 550 | mL | 25.18 | 170 | mL |
| Kibbled wheat | 10.70 | 166.7 | g | 12.35 | 83.35 | g |
| Corn grits | 10.70 | 166.7 | g | 12.35 | 83.35 | g |
| Fine wheat bran | 10.70 | 166.7 | g | 12.35 | 83.35 | g |
| Rice powder | 21.40 | 333.3 | g | 24.70 | 166.7 | g |
| Milled Chelsea white sugar | 10.70 | 166.7 | g | 12.35 | 83.35 | g |
| Paselli BC (Potato starch) | 0.30 | 5.2 | g | 0.39 | 2.6 | g |
| Magnesium stearate | 0.13 | 2.0 | g | | | |
| Premium clover honey | 0.18 | 2.7 | g | 0.20 | 1.38 | g |

*50:50 substrate to build up ratio

### 1.1 Preparation of Bacterial and Spore Suspensions

For each granule production run, the bacteria (Yersinia entomophaga, Serratia entomophila or Serratia proteamaculans) were produced by fermentation or batch culture. Cells were collected by centrifugation (6300 g, 16° C., 10 min) and the pellet was re-suspended with 0.05 M trehalose, making the total volume 25% of the original volume.

The fungus Metarhizium anisopliae var anisopliae (F178) was grown on solid substrate (rice) and wet harvested by washing the rice grains with 0.01% Triton-X 100 resulting in a spore suspension of 3×10⁸/ml for either incorporation into the granule or coating on zeolite granule. Total spore loadings were determined by dissolving the granules in 0.01% Triton-X 100 and performing a haemocytometer count of total spores per gram of granule, and a viable spore count determined through dilution plating onto potato dextrose agar (PDA).

### 1.2 Extruded Bait

Extruded baits were prepared as described in Example 3.

### 1.3 Wet Granulated Bait

Bacterial cell suspension was added to the dry mixture to prepare a dough using a cake mixer at speed “2” for 5-10 min.

The dough was extruded in a wet granulator (FSG TG 2000) using 3.15 mm mesh sieve at 50 rpm speed.

The extruded baits were dried, broken up and sieved as for the extruded baits described in Example 3.

### 1.4 Blinding Sand Coated Bait

Blinding sand coated with the bait matrix was prepared in a Cimbria CC2 laboratory scale seed coating machine. Screened 1-2 mm blinding sand (500 g) was added to the drum and coated with a bait mixture (Table 12) using concentrated bacterial cells suspended in 0.05M trehalose (170 mL) to bind the coating to the core.

### 2. Enumeration of Bacteria and Fungi

Ten-fold serial dilutions of bacterial liquid cultures were prepared in Special M (SpecM) buffer (0.1% Tween-80; 2 mM tetra-sodium pyrophosphate). The resultant dilutions were then plated onto selective agar. Plates were incubated at 30° C. for 48 h and colony counts were recorded as CFU mL⁻¹.

To enumerate Yersinia entomophaga, Serratia entomophila or Serratia proteamaculans in granules, one gram of the granule formulation was weighed out and added to 9 g SpecM buffer. The granules were dispersed in the buffer using a Homogenizer (Polytron) at 11000 rpm for 30-60 seconds until the samples were completely dispersed. Ten-fold serial dilutions were prepared in SpecM buffer and 100 μL aliquots of the relevant dilutions were plated on to selective agar. Plates were incubated at 30° C. for 48 h and counts recorded as CFU per gram (g) of granule.

Spore viability of Metarhizium anisopliae var anisopliae (F178) was determined via an overnight germination test on PDA where viable spores germinate and can be enumerated.

### 2.1 Absorption Assay

One gram of extruded baits containing a pre-determined amount of microorganism were placed onto moist paper towels. Containers were left with their lids raised allowing air flow at room temperature (approximately 22° C.) for the duration of the experiment. At 0, 24, 48, 72 and 96 h post placement on moist filter paper, the samples in triplicates (one random sample from each of the three independent containers) were independently destructively assessed and the amount of microorganism enumerated.

### 3. Assessment of Moisture Content

Pre-weighed baits were dried at 80° C. for 24 h. The dry weight of the sample was recorded and the moisture content calculated according to the formula:

Moisture content (%)=100×(wet weight-dry weight)/wet weight

### 4. Assessment of Water Activity

Water activity was measured using an Aqualab Water Activity Meter Series 3TE (Decagon Devices).

### 5. Assessment of Swellability

Tea bags were independently filled with 0.5 g of each bait immersed in water under stirring for 1 h to allow for maximum uptake of water. The weight of the material before (“dry weight”) and after water uptake (“wet weight”) was recorded in triplicate, and corrected for the dry and wet weight of the tea bag and average results calculated (n=3 replicates). The moisture uptake (swelling) was calculated as % increase in weight using the formula:

Moisture uptake=100×((soaked weight ingredient−soaked weight tea bag)−initial weight ingredient−initial weight tea bag))/(initial weight ingredient−initial weight teabag)

### 6. Assessment of Porosity

Samples were mounted on to aluminium stubs with conductive carbon tape and sputter coated from a gold/palladium source to impart conductivity to the samples.

The samples were studied in a Jeol JSM 7000F Scanning Electron Microscope operating at 10 kV.

### 7. Assessment of Brittleness and Complete Crushing Force

Brittleness (point of fracture) and complete crushing force were measured using an Instron 4204.

The force was measured using the load cell 100 Newton/10 kg, foot area 11134.57 mm² or 11.35 cm², compression speed 10 mm/min, force applied 5 kg and the gauge length 5 mm.

Five baits for each formulation were measured.

### 8. Assessment of Bulk Density

Bulk density of the baits was measured in triplicate (n=3) by measuring the mass of the known volume of bait and expressed in grams per cubic centimetre (g/cm³) derived from the formula:

Bulk density=mass (g)/(volume (mL)

### 9. Porina Bioassay

Individual porina larvae were set up in 100 ml plastic lidded tubes (20 per treatment) filled with a 60:40 mix of soil and peat moistened to 20%, and allowed to burrow overnight before treatments were applied. Two baits (equivalent to 0.060 g) were placed on the soil surface of each tube and the lid replaced. Tubes were checked after 24, 72 and 96 hours for signs of granule consumption. Four days post bait application the larvae were fed with cut ryegrass, then again at day seven, and at seven day intervals thereafter.

### 10. Black Beetle Bioassay

Black beetle adults were confined individually in 12-well trays and fed either carrot cylinders (2.5 mm thick with a diameter of 7 mm, replaced every 2-3 days) or 0.02 g of a Y. entomophaga bait. Sample size was 30 beetles per treatment with a 50:50 male:female ratio. Beetles were kept at 22° C. for the duration of the bioassay.

Moistened Y. entomophaga extruded granules received a single drop of water to increase moisture before being added to the trays.

Beetle mortality was assessed at 1, 7 and 14 days post initiation of the experiment.

### Example 5—Bacterial Growth and Survival in the Bait

### 1. Method

Bacterial survival and growth in extruded baits comprising Yersinia entomophaga, Serratia entomophila or Serratia proteamaculans at two different initial bacterial loadings was determined by absorption assay.

### 2. Results

The results are shown in Table 13.

Irrespective of the initial bacterial loading, the number of viable bacteria in the extruded baits increased to a loading of about 10¹⁰-10¹¹ cfu/g over 96 hours.

TABLE 13
Viable cell counts for Yersinia entomophaga, Serratia entomophila
and Serratia proteamaculans incorporated into extruded baits.

| | Viable cell count (CFU/g ± SD) after | | | | |
|---|---|---|---|---|---|
| Bacteria | 0 h | 24 h | 48 h | 72 h | 96 h |
| Yersinia | 1.73 ± | 1.47 ± | 2.19 ± | 6.40 ± | 1.33 ± |
| entomophaga | 0.15 × 10³ | 0.12 × 10⁵ | 0.19 × 10⁸ | 1.30 × 10⁹ | 0.32 × 10¹⁰ |
| | 3.50 ± | 1.95 ± | 9.03 ± | 2.40 ± | 1.75 ± |
| | 0.52 × 10⁵ | 2.19 × 10⁵ | 1.69 × 10⁸ | 0.35 × 10¹⁰ | 0.09 × 10¹⁰ |
| Serratia | 7.33 ± | 3.96 ± | 8.35 ± | 7.27 ± | 1.72 ± |
| entomophila | 2.08 × 10⁴ | 0.35 × 10⁶ | 0.64 × 10⁹ | 1.96 × 10¹⁰ | 0.15 × 10¹¹ |
| | 1.59 ± | 1.02 ± | 1.11 ± | 2.00 ± | 2.13 ± |
| | 0.11 × 10⁶ | 0.23 × 10⁹ | 0.15 × 10¹¹ | 0.26 × 10¹¹ | 0.32 × 10¹¹ |
| Serratia | 8.90 ± | 1.07 ± | 3.85 ± | 1.00 ± | 1.78 ± |
| proteamaculans | 1.14 × 10⁵ | 0.81 × 10⁹ | 0.48 × 10¹⁰ | 0.23 × 10¹¹ | 0.25 × 10¹¹ |
| | 2.78 ± | 3.17 ± | 1.00 ± | 1.83 ± | 4.13 ± |
| | 0.28 × 10⁷ | 0.38 × 10⁶ | 0.00 × 10⁹ | 0.65 × 10¹⁰ | 0.85 × 10¹⁰ |

### Example 6—Assessment of Baits Comprising an Inert Bulking Agent

### 1. Method

Extruded baits were prepared comprising the bait dough of Table 12 and talc, an inert bulking agent, in a weight ratio of 25:75, 50:50 or 75:25. Baits comprising 100% bait dough were prepared as a control.

Growth of Yersinia entomophaga in the baits was assessed by absorption assay.

### 2. Results

The results are shown in Table 14. The results normalised to the initial cell loading are shown in Table 15.

Irrespective of the initial bacterial loading, the number of viable bacteria in the extruded baits increased to a loading of about 10¹⁰-10¹¹ cfu/g over 96 hours. The addition of an inert bulking agent in the form of talc did not inhibit the growth of Yersinia entomophaga in the baits when used at a ratio of 25:75 or 50:50.

The 75:25 bait had a sloppy texture. The lower growth rate of this bait may reflect the high initial cell loading and that many of the bait's nutritional ingredients may have been utilised by the bacteria at the time of manufacture.

TABLE 14
Viable cell counts for Yersinia entomophaga incorporated
into extruded baits comprising talc.

| Bait | | | | | |
|---|---|---|---|---|---|
| composition | | | | | |
| (Ratio | Viable cell count (CFU/g ± SD) after | | | | |
| talc:dough) | 0 h | 24 h | 48 h | 72 h | 96 h |
| 25:75 | 4.25 ± | 4.56 ± | 3.33 ± | 5.98 ± | 6.82 ± |
| | 1.65 × 10⁶ | 2.26 × 10⁸ | 0.38 × 10¹⁰ | 1.49 × 10¹⁰ | 1.65 × 10¹⁰ |
| 50:50 | 3.23 ± | 8.98 ± | 2.18 ± | 3.54 ± | 4.74 ± |
| | 1.20 × 10⁶ | 3.45 × 10⁸ | 0.08 × 10¹⁰ | 0.12 × 10¹⁰ | 0.76 × 10¹⁰ |
| 75:25 | 3.89 ± | 8.45 ± | 2.28 ± | 2.50 ± | 2.46 ± |
| | 0.42 × 10⁸ | 1.38 × 10⁹ | 0.06 × 10¹⁰ | 0.17 × 10¹⁰ | 0.96 × 10¹⁰ |
| 100% dough | 8.02 ± | 1.28 ± | 6.18 ± | 9.65 ± | 9.92 ± |
| | 0.49 × 10⁶ | 0.43 × 10⁹ | 2.09 × 10¹⁰ | 2.62 × 10¹⁰ | 1.74 × 10¹⁰ |

TABLE 15
Normalised viable cell counts for Yersinia entomophaga
incorporated into extruded baits comprising talc.

| Bait | | | | | |
|---|---|---|---|---|---|
| composition | | | | | |
| (Ratio | Normalised viable cell count after | | | | |
| talc:dough) | 0 h | 24 h | 48 h | 72 h | 96 h |
| 25:75 | 1.00 | 138.06 ± | 9297.05 ± | 15002.97 ± | 19260.65 ± |
| | | 112.15 | 4747.41 | 3463.53 | 10602.96 |
| 50:50 | 1.00 | 322.71 ± | 7569.43 ± | 12418.50 ± | 16507.57 ± |
| | | 220.67 | 2514.50 | 4474.25 | 6290.99 |
| 75:25 | 1.00 | 22.09 ± | 59.33 ± | 65.68 ± | 63.97 ± |
| | | 4.60 | 4.55 | 10.49 | 4.10 |
| 100% dough | 1.00 | 159.46 ± | 7810.09 ± | 12261.38 ± | 12499.30 ± |
| | | 43.24 | 2660.57 | 3774.47 | 2575.20 |

### Example 7—Physical Characteristics of Granules

### 1. Method

Extruded, wet granulated and blinding sand coated baits comprising Yersinia entomophaga, some comprising talc in varying amounts as an inert bulking agent, were prepared.

Viable cell count, water activity, moisture content, density, brittleness and swellability, compressive strength and porosity of the baits were measured.

### 2. Results

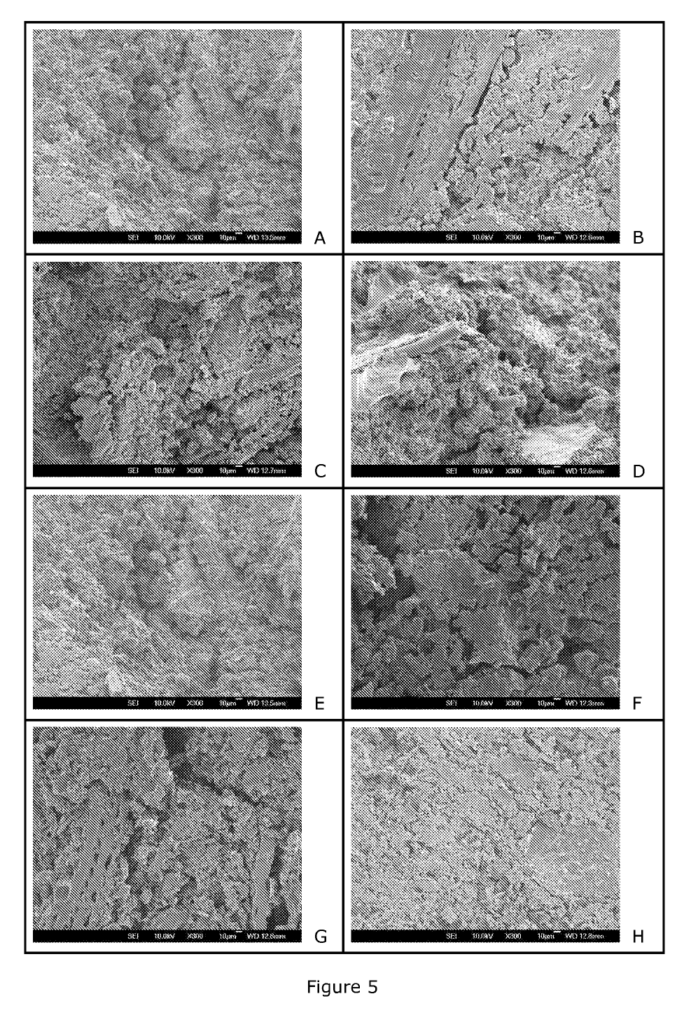

FIG. 5 shows images of the baits captured by a scanning electron microscope.

The physical characteristics of the baits are presented in Table 16.

All baits had a porosity of 0.05-50 μm.

TABLE 16
Cell loading, water activity (a_{w}), moisture content, density,
brittleness, swellability, porosity and force for complete crushing of baits.

| | | | | | | |
|---|---|---|---|---|---|---|
| Cell | | | | | | Force for |
| loading | | Moisture | Density | | | complete |
| (cfu/g) ± | a_{w} ± | content | (g/cm³) ± | Brittleness | Swellability | crushing |
| SD | SD | (%) ± SD | SD | (n) ± SD | (%) ± SD | (N) ± SD |

Standard baits

| | | | | | | | |
|---|---|---|---|---|---|---|---|
| Extruded | 7.7 ± 1.3 × | 0.567 ± | 10.1 ± | 0.54 ± | 26.9 ± 4.08 | 113.3 ± 9.9 | 29.9 ± |
| | 10⁸ | 0.001 | 0.10 | 0.007 | | | 2.65 |
| Wet | 7.7 ± | 0.588 ± | 10.6 ± | 0.52 ± | 26.1 ± 6.67 | 122.7 ± 49.7 | 33.4 ± |
| granulated | 12.0 × | 0.0001 | 0.22 | 0.013 | | | 12.01 |
| | 10⁸ | | | | | | |
| Blinding | 1.7 ± 0.2 × | 0.697 ± | 7.4 ± 0.27 | 0.91 ± | 14.3 ± 6.92 | 86.0 ± 15.6 | 23.9 ± |
| sand | 10⁸ | 0.001 | | 0.007 | | | 9.13 |
| coated | | | | | | | |

Granule size/shape

| | | | | | | | |
|---|---|---|---|---|---|---|---|
| Extruded, | 7.7 ± 1.3 × | 0.567 ± | 10.1 ± | 0.54 ± | 26.9 ± 4.08 | 113.3 ± 9.9 | 29.9 ± |
| cylindrical | 10⁸ | 0.001 | 0.10 | 0.007 | | | 2.65 |
| 1-2.8 mm | | | | | | | |
| Extruded, | 8.2 ± 1.5 × | 0.671 ± | Not | 0.57 ± | Not | 110.7 ± 32.5 | NA |
| star | 10⁹ | 0.001 | determined * | 0.01 | determined^{a} | | |
| shaped, | | | | | | | |
| 10 mm | | | | | | | |

Extruded baits comprising talc

| | | | | | | | |
|---|---|---|---|---|---|---|---|
| 25 talc: | 1.7 ± 1.6 × | 0.636 ± | 8.8 ± 0.14 | 0.58 ± | 10.2 ± 0.88 | 118.0 ± 22.3 | 22.1 ± |
| 75 dough | 10⁶ | 0.0008 | | 0.002 | | | 0.89 |
| 50 talc: | 1.4 ± 1.2 × | 0.465 ± | 4.3 | 0.63 ± | 10.2 ± 0.88 | 122.0 ± 32.1 | 17.5 ± |
| 50 dough | 10⁵ | 0.0003 | | 0.036 | | | 2.45 |
| 75 talc: | 2.4 ± 0.3 × | 0.528 ± | 10.5 | 0.63 ± | 10.2 ± 0.54 | 86.7 ± 40.4 | — |
| 25 dough^{b} | 10⁷ | 0.0001 | | 0.017 | | | |
| Standard | 2.5 ± 3.0 × | 0.647 ± | 12.0 ± | 0.57 ± | 21.6 ± 3.92 | 150.7 ± 17.5 | 26.7 ± |
| extruded | 10⁶ | 0.0004 | 0.07 | 0.005 | | | 7.97 |
| granule | | | | | | | |
| (no talc) | | | | | | | |

^{a}due to shape of the extrusion the brittleness of the granule was unable to be determined.
^{b}extrudability of the granules were not smooth and continuous.

### Example 8—Assessment of Water Activity in Baits Dried Under Controlled Conditions

### 1. Method

Extruded baits were prepared. The baits were dried in a food dehydrator (placed in a room with a constant temperature of 20° C.) and sampled at 2, 4, 6, 24, 30 and 48 h post drying and assessed for cell viability, water activity and moisture content. Temperature and relative humidity monitored inside the food dehydrator using an ibutton data logger, during the experiment period.

### 2. Results

The results are shown in Table 17.

TABLE 17
Yersinia entomophaga cell counts (CFU/g), water activity
(a_{w}) and moisture content (%) of extruded baits post drying.

| Drying | Cell counts | Water activity | Moisture |
|---|---|---|---|
| time (h) | (CFU/g) ± SD | (a_{w}) ± SD | content (%) |
| 1 | 2.1 ± | 0.954 ± 0.0007 | 35.6 |
| | 3.5 × 10¹⁰ | | |
| 4 | 2.3 ± | 0.895 ± 0.0000 | 24.1 |
| | 0.07 × 10¹⁰ | | |
| 6 | 1.8 ± | 0.748 ± 0.0000 | 14.0 |
| | 0.07 × 10¹⁰ | | |
| 24 | 6.3 ± | 0.351 ± 0.0021 | 6.6 |
| | 0.14 × 10⁹ | | |
| 30 | 5.7 ± | 0.329 ± 0.0021 | 6.4 |
| | 0.21 × 10⁹ | | |
| 48 | 7.1 ± | 0.439 ± 0.0000 | 7.8 |
| | 1.2 × 10⁹ | | |

### Example 9—Assessment of Baits Comprising Fungi

Extruded baits were prepared comprising 1.5×10⁸ CFU/g (high rate) or 2.10×10⁵ CFU/g (low rate) of the fungus Metarhizium anisopliae var anisopliae (F178).

The viability of spores in the baits was tested by placing individual granules on 1.5% water agar at 22° C. and assessing spore germination, growth of mycelium and subsequent sporulation.

The high loading rate bait sporulated within 4 days. Hyphae and fungal spores were observed in the low loading rate bait after 7-10 days.

This example demonstrates the utility of the bait as a delivery vehicle for fungal spores.

### Example 10—Effectiveness of Baits Comprising Fungi or Bacteria Against Insects

### 1. Method

Extruded, wet granulated and blinding sand-coated baits comprising Yersinia entomophaga or Metarhizium anisopliae (F178) were prepared. The baits tested are set out in Table 18. Baits comprising no microorganisms were prepared as a control.

A prior art bait that is an existing standard in the field was also prepared. The prior art bait comprised zeolite granules coated in a coating comprising Metarhizium anisopliae (F178).

The insecticidal effectiveness of the baits was tested against porina (Wiseana spp) and black beetle.

TABLE 18
Baits for bioassay testing

| Bacteria/fungi | Formulation |
|---|---|
| Yersinia entomophaga | Ye Extruded granules: extruded bait formulation |
| (Ye) | Ye Wet Granulation: wet granulated bait |
| | formulation |
| | Ye Blinding sand: coated blinding sand bait |
| | formulation |
| | Ye Control: Extruded bait formulation, no |
| | microorganism |
| Metarhzium anisopliae | Ma Zeolite Granule: Granules comprising 24.5% |
| (F178) (Ma) | Ma spore suspension, 0.3% xanthan gum |
| | (stabiliser), 63% zeolite (carrier), 2.4% bentonite |
| | (filler), 9.8% talc (filler) with a theoretical |
| | loading of ~10⁷ spores/g granules |
| | Ma granular formulation Low: extruded bait |
| | formulation with a theoretical loading of ~10⁴ |
| | spores/g granules |
| | Ma granular formulation High: extruded bait |
| | formulation with a theoretical loading of ~10⁷ |
| | spores/g granules |
| | Ma Control: extruded bait formulation, no |
| | microorganism. |

### 2. Results

### 2.1 Porina Bioassay

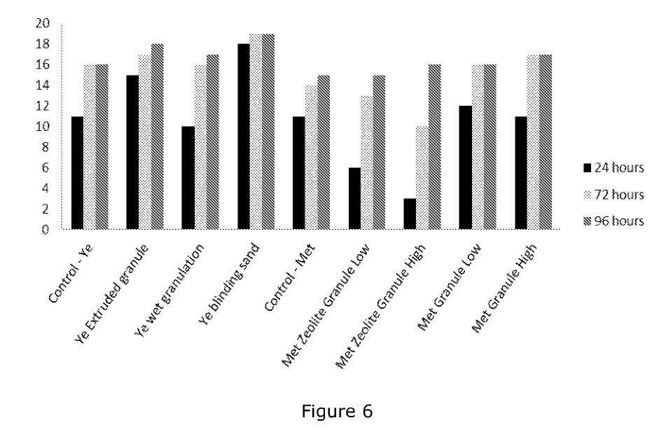

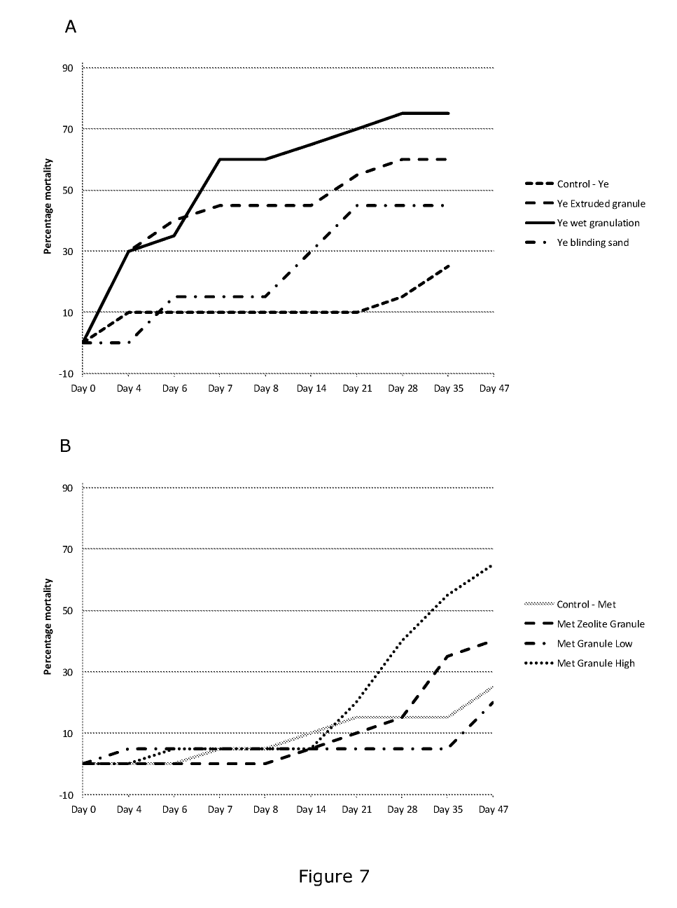

The Metarhizium anisopliae (F178) and Yersinia entomophaga baits were tested. The results are shown in FIGS. 6 and 7.

Test baits and the no microorganism control baits were consumed almost immediately, with the larvae dragging the baits into their burrows. The Metarhizium anisopliae (F178) zeolite granules were not initially consumed although they were pulled into the burrows after 72 hours.

Baits comprising Metarhizium anisopliae (F178) provided greater than 60% efficacy at day 47.

The results demonstrate that baits prepared by all three manufacturing methods are an effective delivery system for the delivery of microorganisms (bacteria or fungi) to a target insect host.

### 2.2 Black Beetle Bioassay

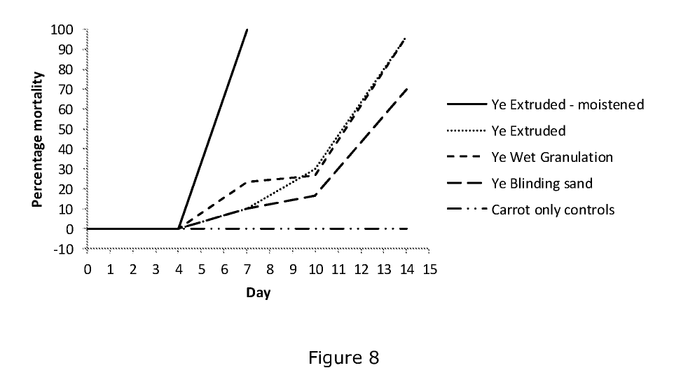

The Yersinia entomophaga baits were tested. The results are shown in FIG. 8.

This example demonstrates that baits prepared by three different manufacturing methods are effective for the delivery of microorganisms (bacteria or fungi) to a target insect host.

1. A granular composition comprising one or more microorganisms, two or more plant powders and a biodegradable water-absorbent agent capable of absorbing at least 10% of its dry weight in water.

2. A composition of claim 1 wherein the one or more microorganisms are fungi.

3. A composition of claim 1 wherein the one or more microorganisms are bacteria.

4. A composition of claim 2 or 3 wherein the fungi are selected from Beauveria, Penicillium, Metarhizium, Trichoderma, Gliocladium, Coniothyrium, Verticillium, Sclerotinia or a combination of any two or more thereof, and/or the bacteria are selected from Serratia, Xanthamonas, Pseudomonas, Rhizobium, Bifidobacterium, Lactobacillus, Streptococcus, Yersinia, Pseudomonas, Bacillus, Pasteuria, Azobacter, Enterobacter, Azospirillum, Cyanobacteria, Paecilomyces, Streptomycetes, Chromobacterium, Rhanella, Burkholderia, Paenibacillus, Collimonas, Sinorhizobium, Pantoea, Lecanicillum, Erwinia, Pediococus, Leuconostoc, Aeromonas, Neptunomonas, Klebsiella, Ponchonia, Brevibacillus, Acinetobacter or a combination of any two or more thereof.

5. A composition of claim 3 or 4 having a bacterial loading of less than about 10¹¹ to about 10⁴ cells per gram of granular composition.

6. A composition of claim 1 or 2 having a loading of one or more microorganisms less than 10¹⁰ to about 10⁴ cells per gram of granular composition.

7. A composition of any one of claims 1 to 6 having
a) a bulk density of from about 0.2 g/cm³ to about 1.5 g/cm³, or
b) a mean diameter (weight-based) of from about 1 mm to 5 mm, or
c) a particle size distribution whereby at least 90% of the granular composition has a diameter of from 1 mm to 5 mm, or
d) a particle size distribution whereby at least 90% of the granular composition have a diameter within 1 mm of the mean diameter, or
e) a water activity of from about 0.2 to about 0.95, or
f) a hardness of from about 10 N to about 100 N, or
g) a brittleness of from about 10 N to about 100 N, or
h) a porosity of from about 1 to about 1000, or
i) a swellability of from about 20 to about 300%, or
j) any combination of two or more of (a) to (i) above.

8. A composition of any one of claims 1 to 7 comprising
a) about 0.05 to about 5% by weight of a biodegradable water-absorbent agent, or
b) a phagostimulant, or
c) one or more polysaccharides, or
d) at least about 5 to about 50% by weight plant powders, or
e) a lubricant, or
f) a substrate, or
g) a densifier, or
h) one or more processed cereals as the two or more plant powders, or
i) an active agent selected from one or more of an insecticide and a probiotic, or
j) any combination of two or more of (a) to (i) above.

9. A composition of any one of claims 1 to 8 having
a) a mean diameter of about 0.5 to about 10 mm, or
b) a moisture content of about 5 to about 25% by weight, or
c) a water activity (a_{w}) of less than about 0.55 to about 0.95, or
d) any combination of two or more of (a) to (c) above.

10. A composition of any one of claims 1 to 9 wherein the biodegradable water-absorbent agent is capable of absorbing at least 10 to about 100% water based on its dry weight, or about 100 to about 1000% water based on its dry weight.

11. A composition of any one of claims 1 to 10 wherein the biodegradable water-absorbent agent is selected from the group comprising starches, cross-linked polymers, and peat.

12. A composition of any one of claims 1 to 10 wherein the biodegradable water-absorbent agent is a polymer.

13. A composition of any one of claims 1 to 12 comprising at least about 1×10⁶ cfu/g after storage at 4° C. for 14 days.

14. A composition of any one of claims 1 to 13 when used retains its integrity for at least about 48 hours after contacting about 0.1 to about 1.0 mL of water per gram of granular composition.

15. A composition of any one of claims 1 to 14 wherein the two or more plant powders comprises a bran as at least one of said two or more plant powders.

16. A composition of claim 15 comprising, in addition to bran, a plant powder selected from the group comprising wheat flour, rice powder, oat flour, barley flour, rye flour, triticale flour, corn (maize) flour, amaranth flour, millet flour, teff flour, quinoa flour, buckwheat flour and sorghum flour or a combination of any two or more thereof.

17. A composition of claim 15 or 16 comprising a ratio of bran to the one or more other plant powders of about 8:1 to about 1:4 by weight.

18. A composition of any one of claims 15 to 17 comprising a ratio of bran to the one or more saccharides of about 5:1 to about 1:5 by weight.

19. A composition of any one of claims 15 to 18 comprising a ratio of the one or more plant powders to the one or more saccharides of about 8:1 to about 1:4 by weight.

20. A composition of any one of claims 1 to 19 comprising about 1×10² to about 1×10¹¹ colony forming units (cfu's) of the one or more microorganisms per gram of the composition after about 1 day to about 24 months after storage when stored at a temperature of about 4 to about 20° C.

21. A method of producing a granular composition comprising admixing a composition comprising two or more plant powders and a biodegradable water-absorbent agent capable of absorbing at least 30% of its dry weight in water, and
A) one or more lubricants to form a dough, and processing the dough to form granules, or
B) coating a substrate with the dough to form the granular composition,
wherein
i) the admixture comprises one or more microorganisms, or
ii) the dough is coated with an exterior coating comprising one or more microorganisms, or
iii) both (i) and (ii).

22. A method of claim 21 wherein the dough is an extruded dough.

23. A method of claim 22 wherein the granular composition is formed by wet granulation.

24. A method of any one of claims 21 to 23 wherein the granular composition is dried to a water activity (a_{w}) of less than about 0.2 to about 0.95.

25. The use of the granular composition of any one of claims 1 to 21 on soil to
a) kill or control pests, such as insect pests, or
b) reduce the population of a pest, such as an insect pest, or
c) maintain or increase plant or crop growth, or
d) maintain or increase pasture production, or
e) maintain or increase plant, crop or pasture yield, or
f) deliver probiotics to grazing animals or livestock, or
g) bioremediate the soil, or
h) a combination of any two or more of a) to g).

26. The use of a composition of claim 25 wherein the granular composition is applied to soil
a) at a rate of at least about 5 to about 200 kg per hectare, or
b) at a rate of at least about 1×10⁹ to about 1×10¹⁵ cfu of the one or more microorganisms per hectare, or
c) to target a pest wherein the application of the granular composition to soil reduces the population of the targeted pest by about 10 to about 100% in the 4 months following application, or
d) and retains about 0.1 to about 100% viability from 1 day to about 24 months after application, or
e) and wherein the one or more microorganisms are detectable in the soil for up to about 1 to about 10 weeks or about 3 to about 12 months after application of the granular composition to soil, or
f) a combination of any two or more of a) to e).

27. A method of delivering one or more microorganisms to soil, comprising applying the granular composition of any one of claims 1 to 20 to soil.

28. A method of delivering one or more microorganisms to animal feed, comprising applying the granular composition of any one of claims 1 to 20 to soil.

29. A method of controlling insect pests, the method comprising placing insecticidal granular compositions in proximity to an insect pest, the granular compositions being as claimed in any one of claims 1 to 20.

30. A granular composition as herein described in any one or more of the examples herein.
